(19) United States
(12) Patent Application Publication
(10) Pub. No.: US 2018/0033110 A1
(43) Pub. Date: Feb. 1, 2018

(54) APPARATUS, METHOD AND SYSTEM TO VERIFY META DATA OF A PERSON

(71) Applicant: IPAGOO LLP, London (GB)

(72) Inventor: Carlos SANCHEZ, Sevenoaks (GB)

(73) Assignee: ORWELL UNION PARTNERS LLP, London (GB)

(21) Appl. No.: 15/548,171

(22) PCT Filed: Feb. 2, 2016
(86) PCT No.: PCT/GB2016/050239

§ 371 Date: Aug. 2, 2017

(30) Foreign Application Priority Data
Feb. 3, 2015 (GB) 1501809.6

(51) Int. Cl. G06Q 50/26; G06F 17/30

(52) U.S. Cl. CPC G06Q 50/265; G06F 17/30241; G06F 17/30268

(57) ABSTRACT

One or more embodiments of the present invention provide a data processing apparatus operative to automatically verify meta data of a natural or legal person submitted to the data processing apparatus, the data processing apparatus configured to: establish a communications session with a communications terminal through a first communications system; receive from the communications terminal first address data defining a geographic location for the communications terminal; derive a first geographic location for the communications terminal from the first address data; and compare the first geographic location with a street address supplied to the data processing apparatus for the natural or legal person to determine a first geographic correspondence between the first geographic location and the street address. One or more embodiments of the present invention also provide a communications terminal operative for receiving input of meta data of a natural of legal person, a system operative to automatically verify meta data of a natural or legal person, and a method of operating the data processing apparatus.

### FIELD

The present invention relates to a data processing apparatus, system and method for verifying meta data of a natural or legal person. In particular, but not exclusively, verifying meta data for identity proofing of the natural or legal person.

### BACKGROUND

Identity proofing and verification (IPV) is an essential aspect of delivering financial services, such as banking services, and other services utilising personal and other data (meta data) of an entity to that entity. Such entities are either natural persons, i.e. real human beings, or legal persons, i.e. a business entity (private legal person) or a government entity (public legal person). In the following the term “person” shall mean natural or legal person unless the context requires otherwise. In the United Kingdom (UK) guidelines have been provided for IPV by way of “Good Practice Guide No. 45, Identity Proofing and Verification of an Individual”, Issue No: 2.3, July 2014, jointly issued by CESG, the UK's National Technical Authority on Information Assurance and Cabinet Office, Government Digital Service.

In general outline, the guidelines suggest that IPV should enable a legitimate person to prove their identity relatively easily but make it difficult for a person attempting to pass themselves off as someone else. This requires a person to state their claimed identity and provide evidence to prove that claimed identity. The guidelines suggest that the evidence should “be confirmed as being valid and/or enforceable and belonging to the individual”.

Evidence has traditionally been provided in person or by post and consisted of certified copies of birth certificates and/or passports of the person claiming an identity and copies of recent utility bills bearing the address the person claims as their residence. For a legal person, a certificate of incorporation may be provided instead of a birth certificate or passport. With the rise of internet-based business, often termed “e-business”, a person claims an identity often through an internet established session with a business entity's internet communication systems. This may include the provision of traditional documentary evidence provided to the business entity through conventional routes such as postal services or uploading copies of such documents via email or the internet session. Typically, the person claiming the identity will also be required to enter the name, date of birth and street address of the person whose identity they are claiming into a web page form provided by the business entity's internet communications system to the communications terminal with which the internet session has been established. The details input over the internet may then be confirmed by the traditional evidence but such confirmation requires human intervention and may introduce significant delays into the IPV process.

A person's physical existence can generally be defined by that person's residence or domicile (e.g. home address or office building). Currently, verification of that person's physical existence is with reference to documentation, i.e. identity evidence, provided by the person which shows that the person can claim to be resident at a given address. For example, a recent Council Tax bill, motor insurance or home insurance certificate, a government income tax notice issued to the person, a recent Bank, Building Society, or Credit Union statement, or a recent utility bill.

Greater confidence that a person's given address is an address where they actually reside could be obtained by interviewing the person at the given address. This suggests a residence or domicile there. However, in all but the most sensitive environments, this is not cost effective and may be too lengthy a process.

Aspects and embodiments of the present invention were devised with the foregoing in mind.

### SUMMARY

Viewed from a first aspect there is provided a data processing apparatus operative to automatically verify meta data of a natural or legal person submitted to the data processing apparatus, the data processing apparatus configured to:
establish a communications session with a communications terminal through a first communications system;
receive from the communications terminal first address data defining a geographic location for the communications terminal;
derive a first geographic location for the communications terminal from the first address data; and
compare the first geographic location with a street address supplied to the data processing apparatus for the natural or legal person to determine a first geographic correspondence between the first geographic location and the street address.

Viewed from a second aspect there is provided a method of operating data processing apparatus operative to automatically verify meta data of a natural or legal person submitted to the data processing apparatus, the method comprising:
establishing a communications session with a communications terminal through a first communications system;
receiving from the communications terminal first address data defining a geographic location for the communications terminal;
deriving a first geographic location for the communications terminal from the first address data; and
comparing the first geographic location with a street address supplied to the data processing apparatus for the natural or legal person to determine a first geographic correspondence between the first geographic location and the street address.

The first address data may be a network address, e.g. an IP address, for a router or other network interface, connected to the communications terminal, which may be a PC, laptop, tablet or other network connected communications device. The first address data may be of a cell-mast for a phone using a cellular communication system or GPS data corresponding to the location of the user when or soon after engaging in the communication.

In an embodiment the first geographic correspondence comprises a measure of geographic proximity between the first geographic location and the street address. This is to check that the communications terminal is being used from a geographic location corresponding to the street address supplied by the person because a person who has rights to a residence is likely to be using their communications terminal from that residence. This or one or more other embodiments may be configured to determine if the first geographic correspondence satisfies a first geographic criterion such as the first geographic location and street address being within a predefined distance of each other and/or the first geographic location comprising a geographic locality such as may be defined by a zip code, UK post code or other postal address code.

Typically an embodiment indicates a first positive verification of the street address for the first geographic correspondence satisfying the first geographic criterion.

In an embodiment the first address data is supplied from geolocation apparatus and is indicative of the geographic location of the geolocation apparatus. Such an arrangement is useful where there are no other suitable technological systems independent of the persons control for providing an indication of geographic location.

Optionally, the first address data is address data assigned to a communications origination point for the communications terminal by the first communications system. For a communications session using the internet the origination point may be the IP address of the terminal equipment or the equipment through which it accesses the internet. This is a convenient way of identifying, independently of the person, the geographic location of the communications terminal used by that person when there is a correspondence between an IP address and the geographic location of the equipment assigned to that address.

An embodiment utilising IP addresses may provide a message for presentation through a user interface of the communications terminal requesting input of second address data assigned by a second communications system to geolocation apparatus indicative of the geographic location of the geolocation apparatus; receive the second address data and determine a second geographic location corresponding to the geographic location of the geolocation apparatus from the second address data; and compare the street address with the second geographic location to determine a second geographic correspondence between the street address and second geographic location. Such an embodiment may provide further verification of the geographic location of the communications terminal or at least the location of the person using the communications terminal.

Suitably, the second geographic correspondence comprises a measure of geographic proximity between the second geographic location and the street address and/or a second geographic criterion.

Typically, such an embodiment will indicate a second positive verification of the street address for the second geographic correspondence satisfying the second geographic condition such as the second geographic location and street address being within a predefined distance of each other. Generally, although not always, the second geographic correspondence and/or the second geographic criterion are the same as respective first geographic correspondence and first geographic criterion.

Typically, the geolocation apparatus is configured to receive signals from a satellite system for determining global position of the geolocation apparatus such as the Global Positioning System (GPS), GLONASS or the European Union GALILEO system.

In embodiments utilising geolocation apparatus configured to receive signals from satellite systems the second address data is supplied from the geolocation apparatus and is indicative of the geographic location of the geolocation apparatus.

Typically, the second address data further comprises a time stamp corresponding to when the second address data was instantiated, the time stamp being compared with the time the message was provided for presentation on the user interface; and a time difference between the time indicated by the time stamp and the time the message was provided being determined. Suitably, the time stamp includes a date. Such an embodiment typically indicates a third positive verification of the street address for the time difference being less than a predefined time period.

In one or more embodiments, the geolocation apparatus comprises a camera and the second address data is included with an image file corresponding to an image captured by the camera.

Such image files typically include date and time information and so a global positioning enabled camera is a convenient device for providing the geolocation data.

An embodiment may initiate a search of one or more databases for one or more images corresponding to the location defined by the second address; compare at least one of the one or more images with the captured image to determine a level of correspondence therebetween; and indicate a fourth positive verification of the street address for the level of correspondence being sufficiently great. Typically a numeric value is derived and a threshold level predefined and if the determined correspondence level exceeds the threshold level a positive verification may be indicated.

One or more embodiments may provide in the message a request for an image of the natural person engaging in the communications session; initiate a search of one or more databases for one or more images corresponding to the name of the natural person; compare at least one of the one or more images with the image to determine a level of correspondence therebetween; and indicate a fifth positive verification of the identity of the natural person for the level of correspondence being sufficiently great.

An embodiment in which a geolocation enabled camera is not used to determine geolocation may also provide a personal image request message requesting an image of the natural person engaging in the communications session; initiate a search of one or more databases for one or more images corresponding to the name of the natural person; compare at least one of the one or more images with the image to determine a level of correspondence therebetween; and indicate a sixth positive verification of the identity of the natural person for the level of correspondence being sufficiently great.

Embodiments utilising images of the person may provide a further verification of the identity of a person from sources independent of the person, such as social networking sites and/or information obtainable from the internet and world wide web. Such an approach may be considered a form of “crowd sourcing” of identity verification.

One or more embodiments may establish a confirmed positive verification of the street address based on one or more of the first, second, third or fourth positive verification and/or establish a confirmed positive verification of the natural person based on the fifth or sixth positive verification.

Viewed from a third aspect there is provided a communications terminal operative for receiving input of meta data of a natural of legal person, the communications terminal configured to:
establish a communications session with a data processing apparatus through a first communications system;
encrypt first address data defining a geographic location for the communications terminal;
transmit encrypted first address data to the data processing apparatus.

Viewed from a fourth aspect there is provided a method of operating a communications terminal for receiving input of meta data of a natural of legal person, the method comprising: establishing a communications session with a data processing apparatus through a first communications system; encrypting first address data defining a geographic location for the communications terminal; transmitting encrypted first address data to the data processing apparatus.

Embodiments in accordance with the third and fourth aspects provide an application running on the communications terminal which can provide greater control, security and confidence in the data being supplied from it.

At least one embodiment of a communications terminal encrypts input meta data of a natural or legal person; and transmits encrypted input meta data of the natural or legal person to the data processing apparatus. In this way, the meta data can be protected from interference by unauthorised persons.

In one or more embodiments the first address data defines a geographic location for the communications terminal. Suitably, the first address data further comprises a first time stamp corresponding to when the first address data was instantiated; the first time stamp being encrypted and the encrypted first time stamp data being transmitted to the data processing apparatus.

Suitably, the first address data is supplied from geolocation apparatus and is indicative of the geographic location of the geolocation apparatus.

Optionally, the first address data is address data assigned to a communications origination point for the communications terminal by the first communications system.

One or more embodiments may receive second address data assigned by a second communications system to geolocation apparatus indicative of the geographic location of the geolocation apparatus; encrypt the second address data; and transmit encrypted second address data to the data processing apparatus.

Typically, the second address data comprises geolocation data such as obtainable from satellite systems, e.g. GPS, GLONASS and/or GALILEO.

In one or more embodiments the second address data further comprises a second time stamp corresponding to when the second address data was instantiated, and wherein the second time stamp is encrypted and transmitted to the data processing apparatus.

In an embodiment the communications terminal may comprise a camera, wherein the communications terminal is configured to include the second address data and a third time stamp in an image file corresponding to an image captured by the camera, the third time stamp corresponding to when the image was captured by the camera.

In an embodiment the communications terminal may be further configured to: encrypt the third time stamp; encrypt the image file; transmit encrypted third time stamp data and encrypted image file data to the data processing apparatus. An embodiment may be further configured to: receive an image file; encrypt the image file; and transmit encrypted image file data to the data processing apparatus.

Viewed from a fifth aspect, there is disclosed a system operative to automatically verify meta data of a natural or legal person, comprising: a data processing apparatus and a communications terminal as disclosed above.

One or more specific embodiments in accordance with aspects of the present invention will be described, by way of example only, and with reference to the following drawings in which:

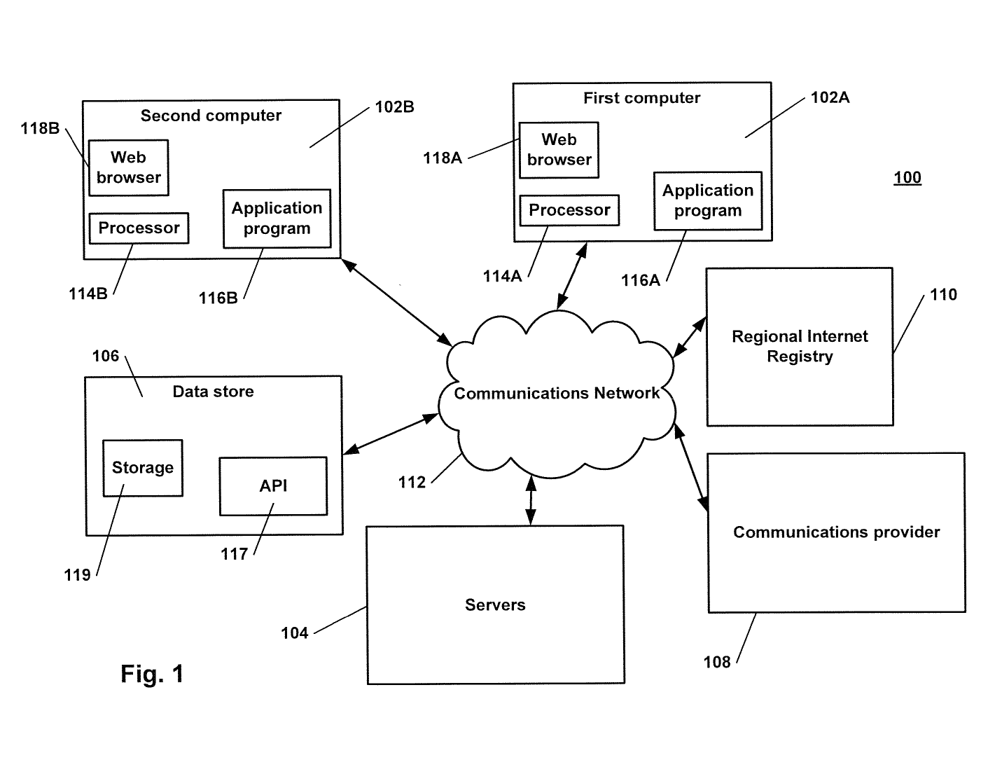

FIG. 1 schematically illustrates an overview of a system comprising an apparatus in accordance with one or more embodiments of the present invention;

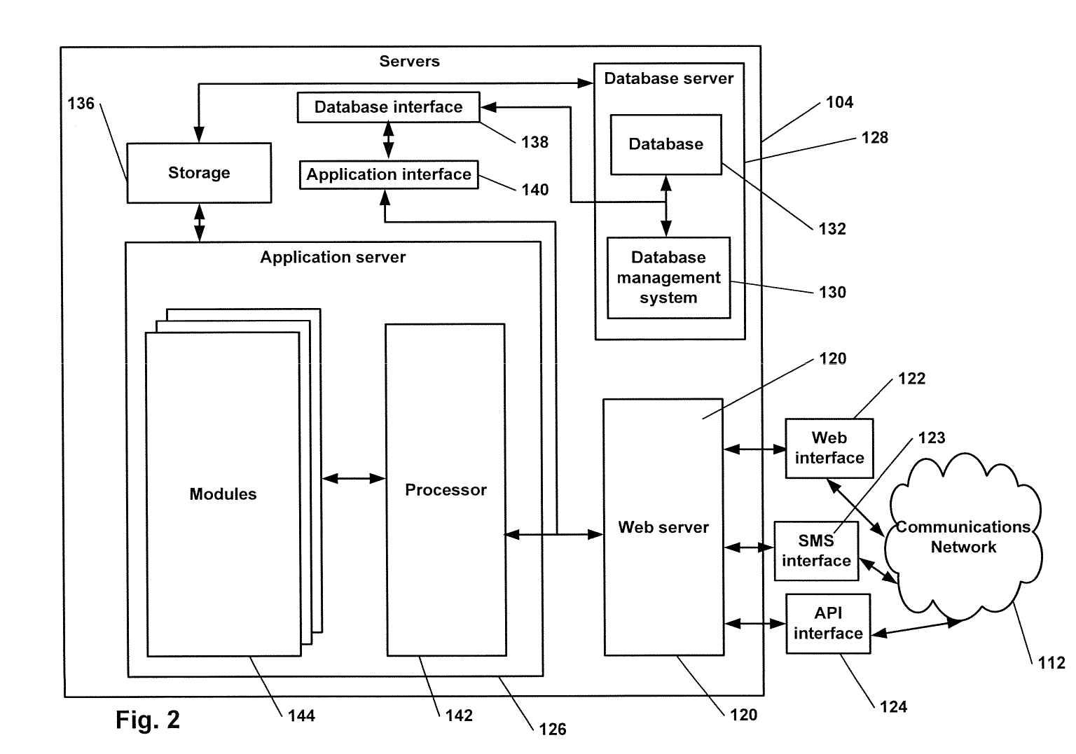

FIG. 2 schematically illustrates a cluster of servers in accordance with one or more embodiments of the present invention;

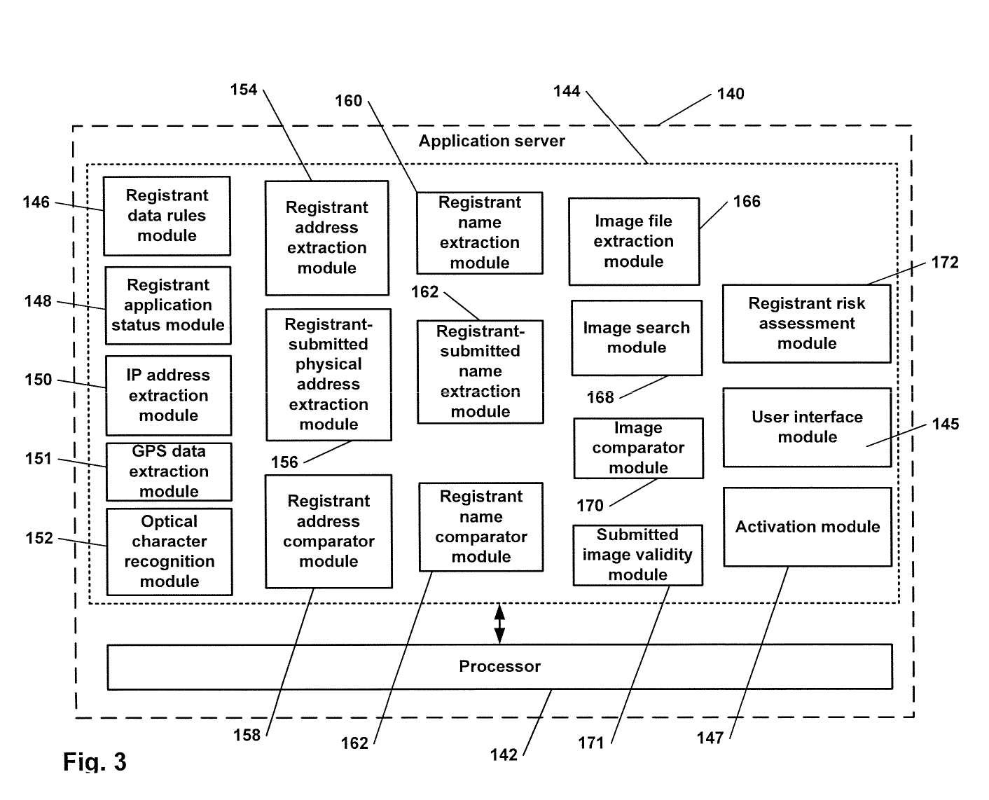

FIG. 3 schematically illustrates an application server of the cluster of servers in accordance with one or more embodiments of the present invention;

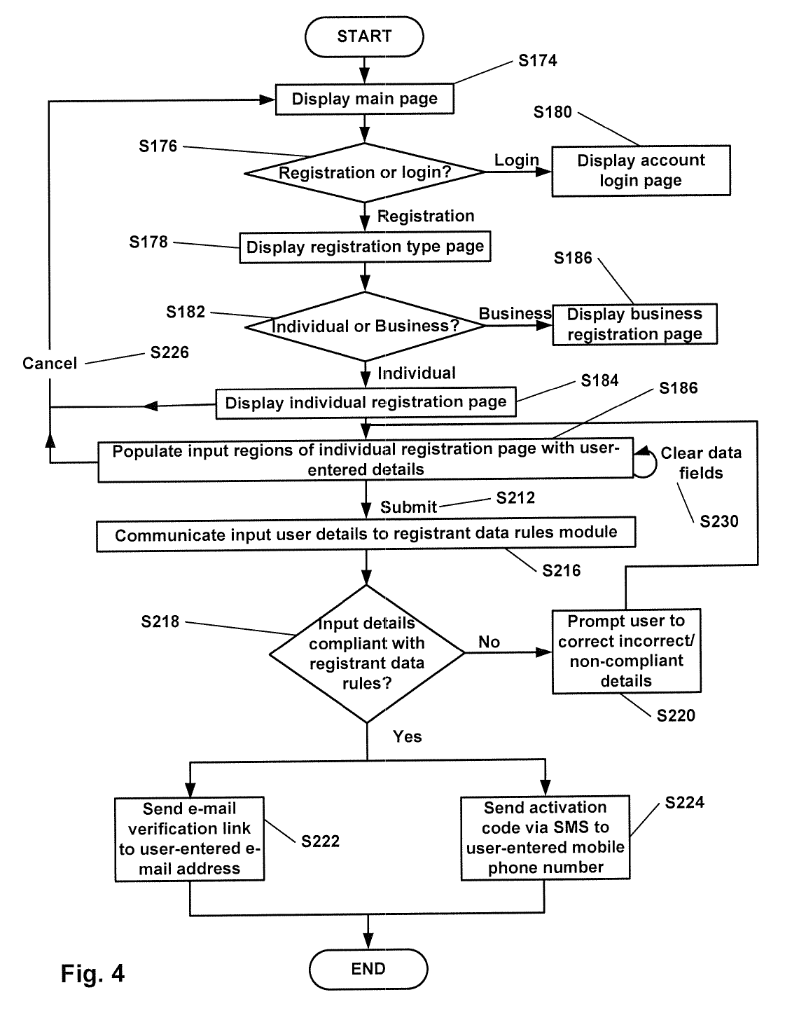

FIG. 4 schematically illustrates a process flow control diagram for a first part of a user-registration process on a system in accordance with one or more embodiments of the present invention;

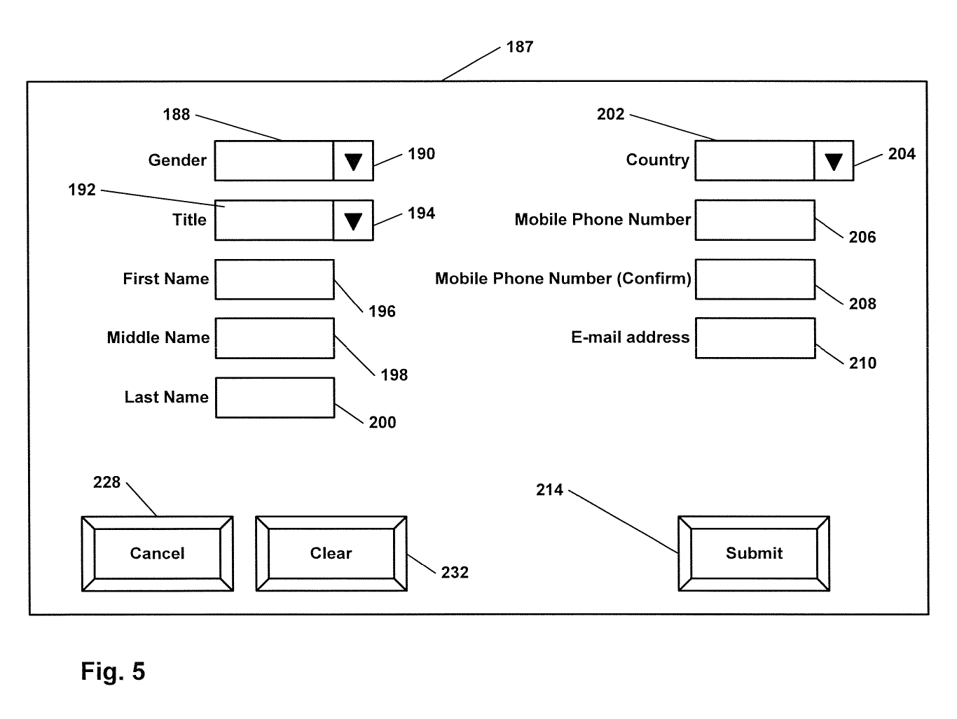

FIG. 5 schematically illustrates a user interface for entering user details to be used in the first part of the user-registration process on a system in accordance with one or more embodiments of the present invention;

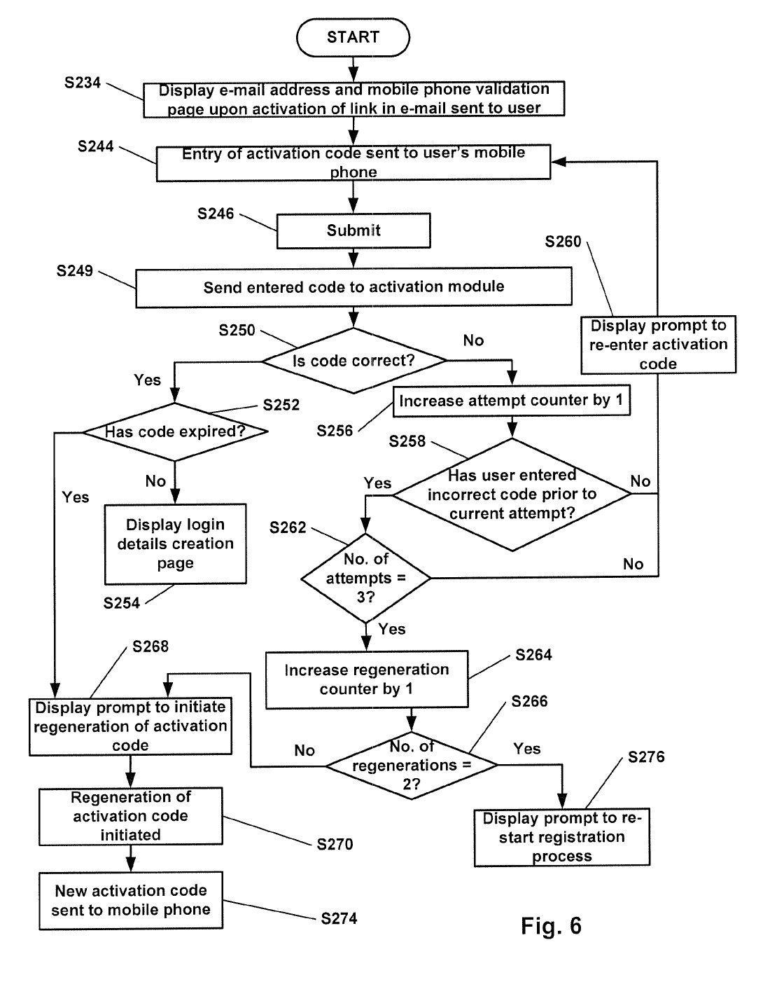

FIG. 6 schematically illustrates a process flow control diagram for validation of a user e-mail account and mobile phone number on a system in accordance with one or more embodiments of the present invention;

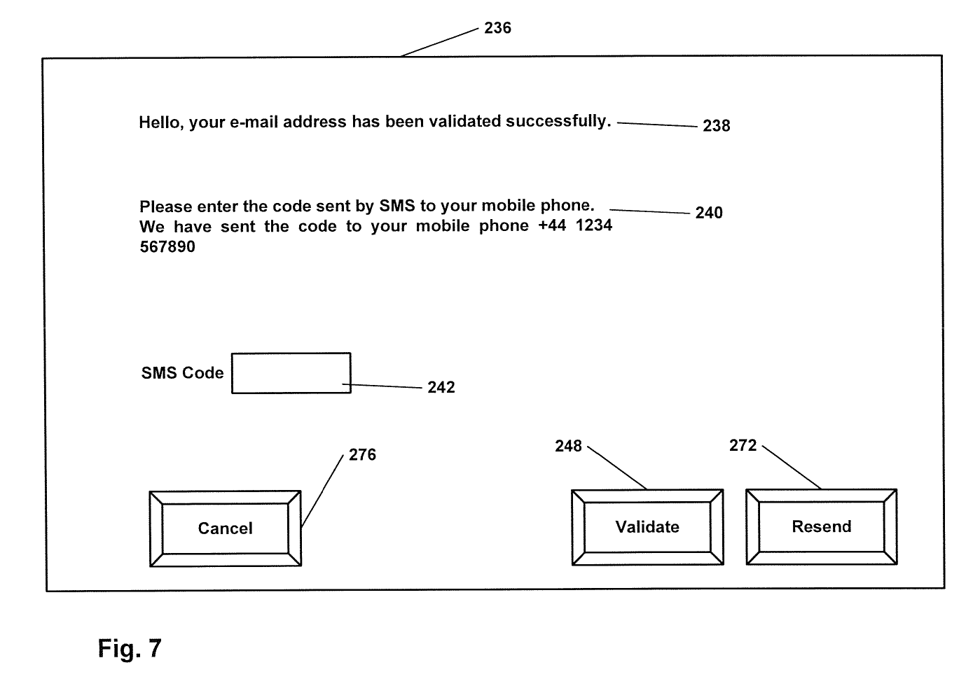

FIG. 7 schematically illustrates a user interface for entering a code to be used in the user e-mail account and mobile phone number validation process on a system in accordance with one or more embodiments of the present invention;

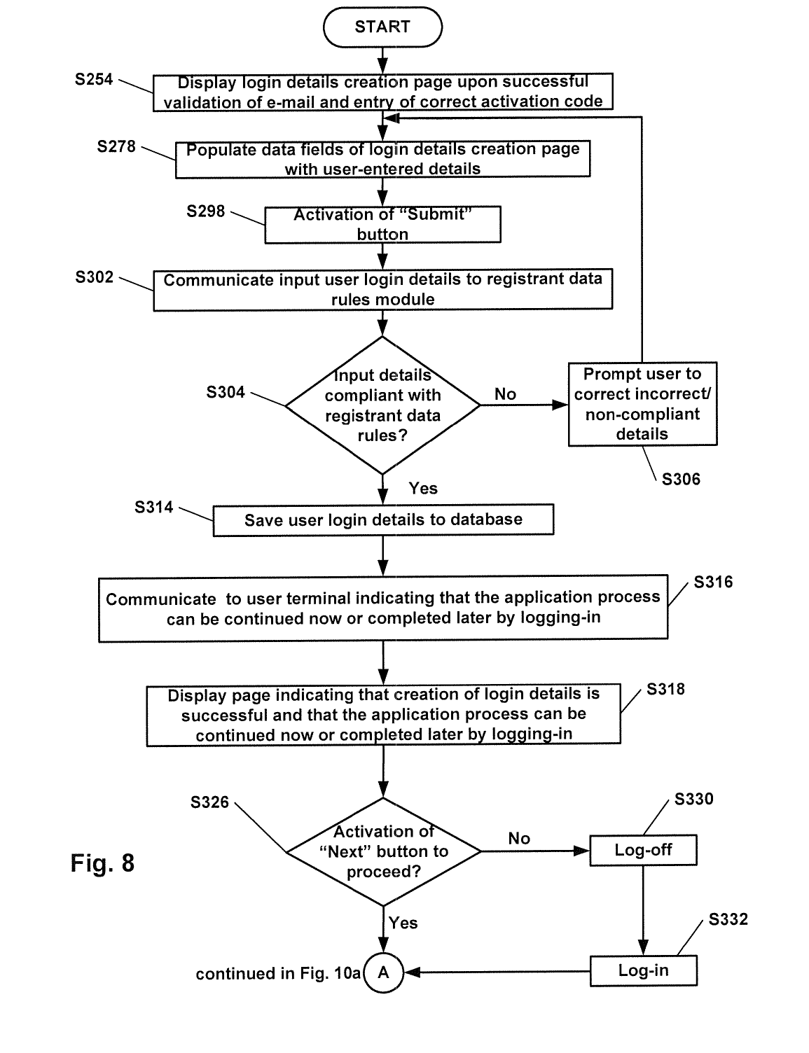

FIG. 8 schematically illustrates a process flow control diagram for a second part of the user-registration process on a system in accordance with one or more embodiments of the present invention;

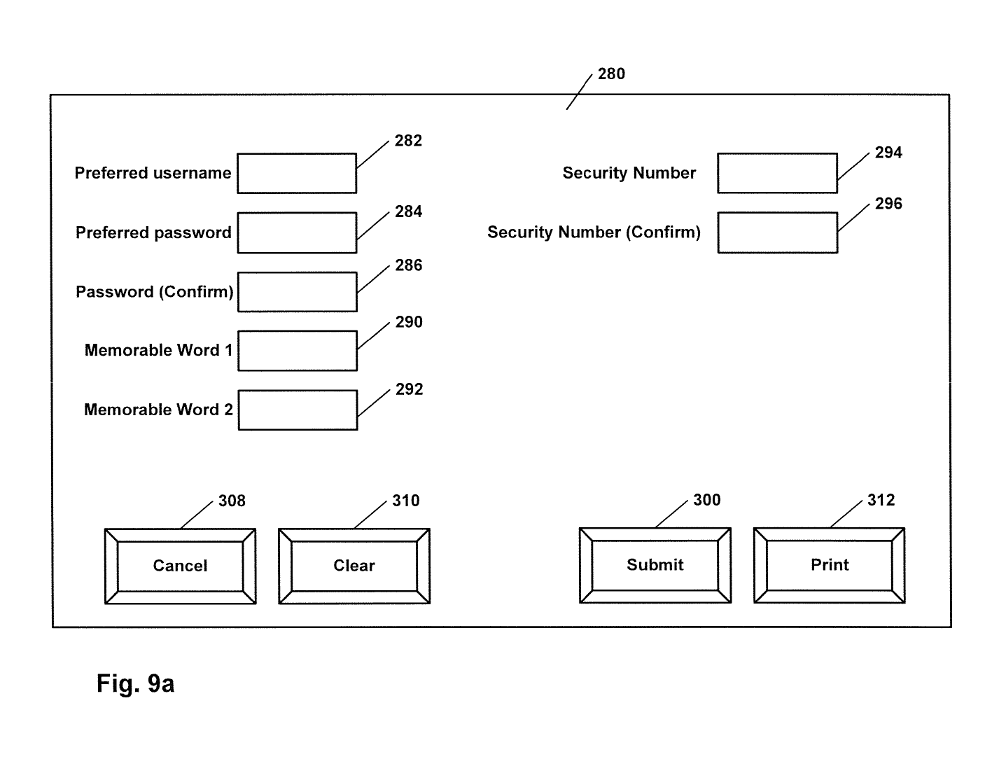

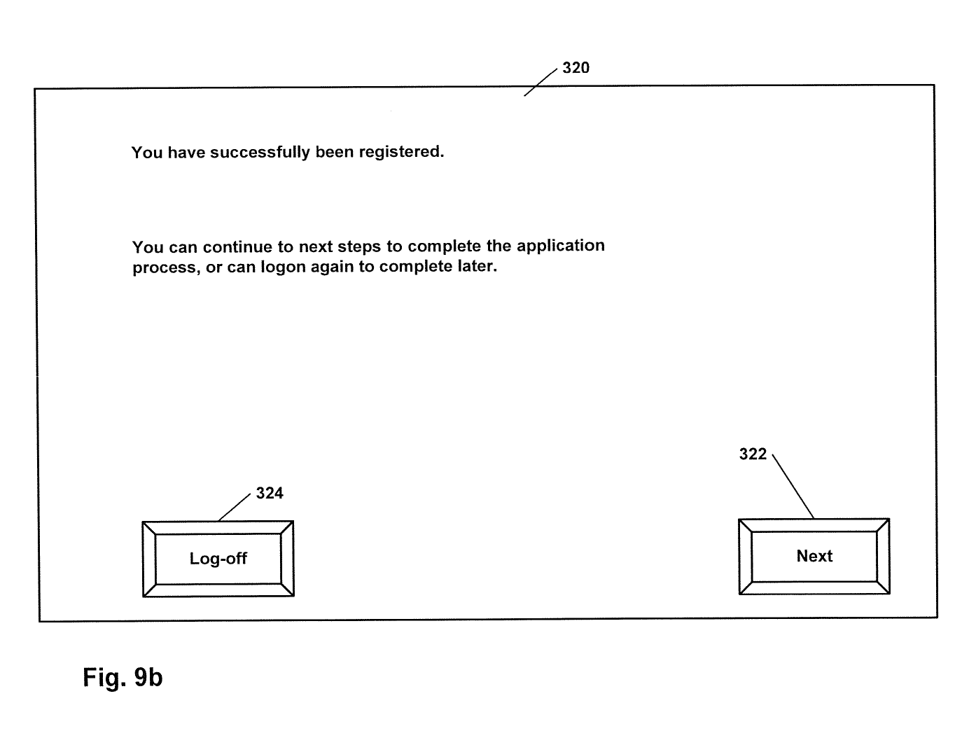

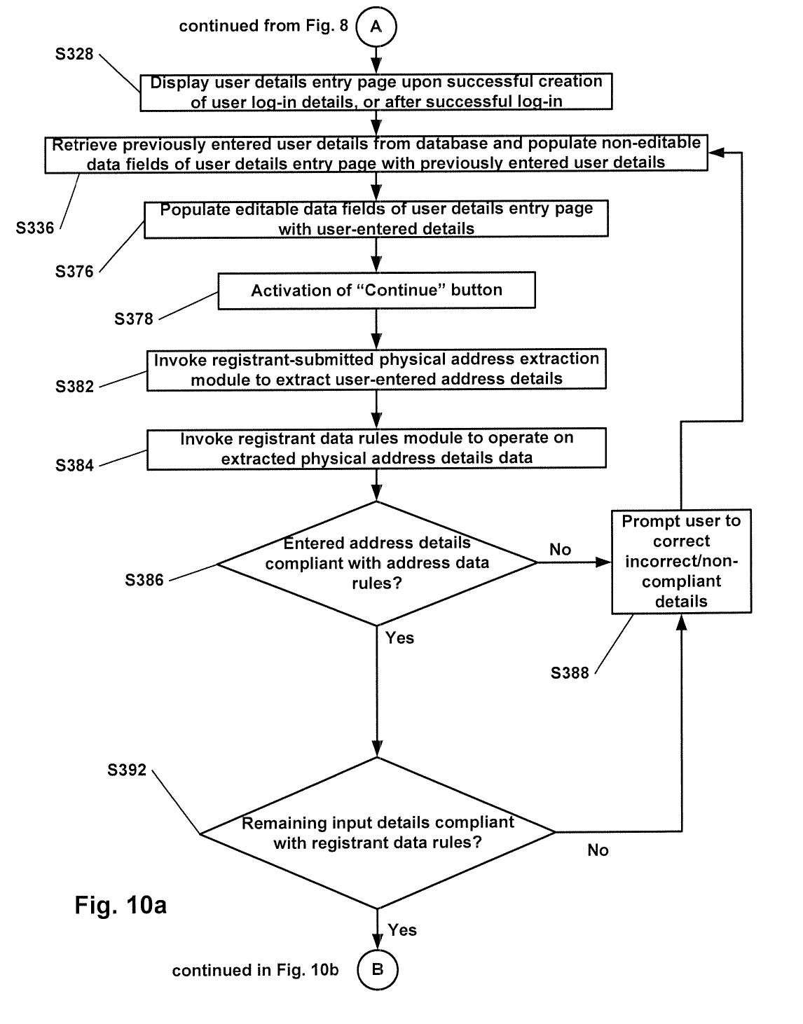

FIG. 9a schematically illustrates a user interface for entering details to be used in the second part of the user-registration process on a system in accordance with one or more embodiments of the present invention;

FIG. 9b schematically illustrates a user interface for initiating entry into an account-application process or exit prior to initiation of the account-application process;

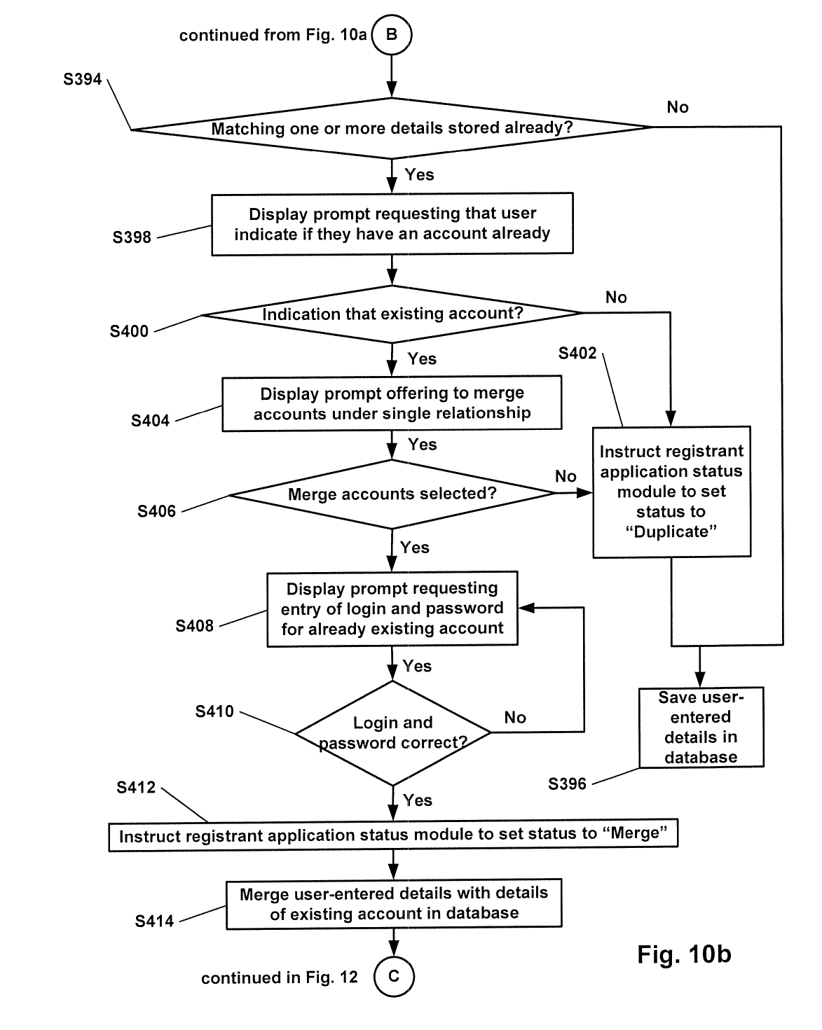

FIGS. 10a and 10b schematically illustrate a process flow control diagram for a first part of the account-application process on a system in accordance with one or more embodiments of the present invention;

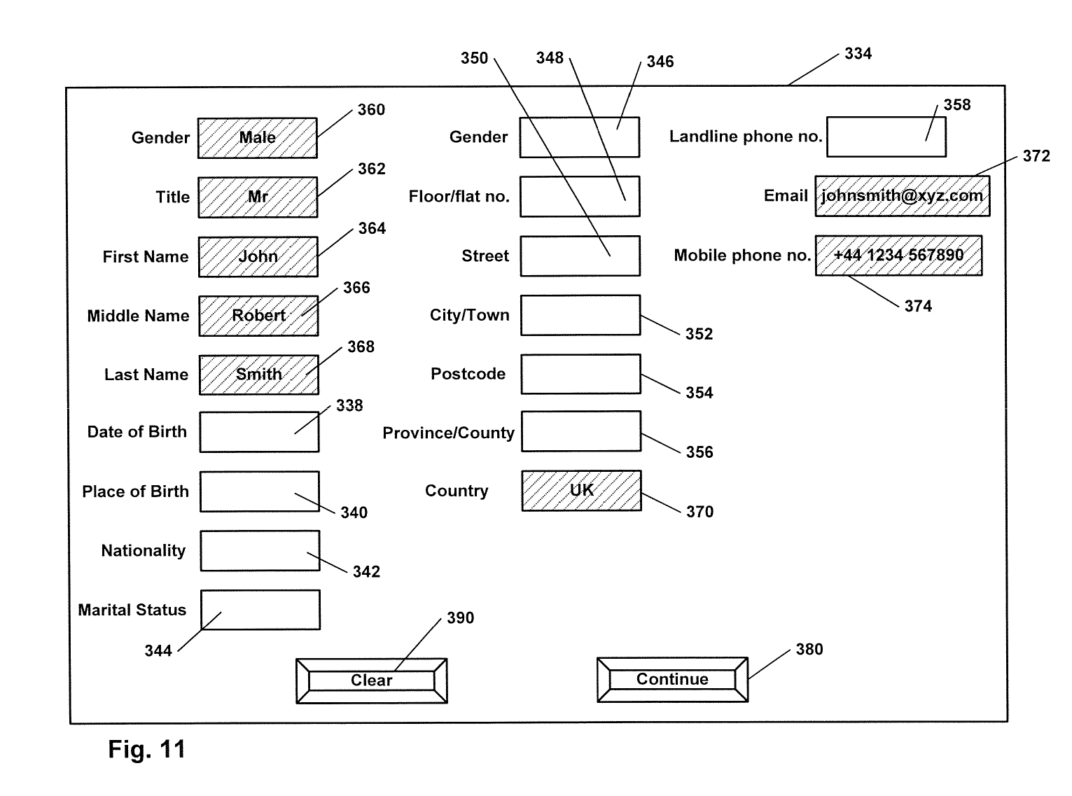

FIG. 11 schematically illustrates a user interface for entering details to be used in the first part of the account-application process on a system in accordance with one or more embodiments of the present invention;

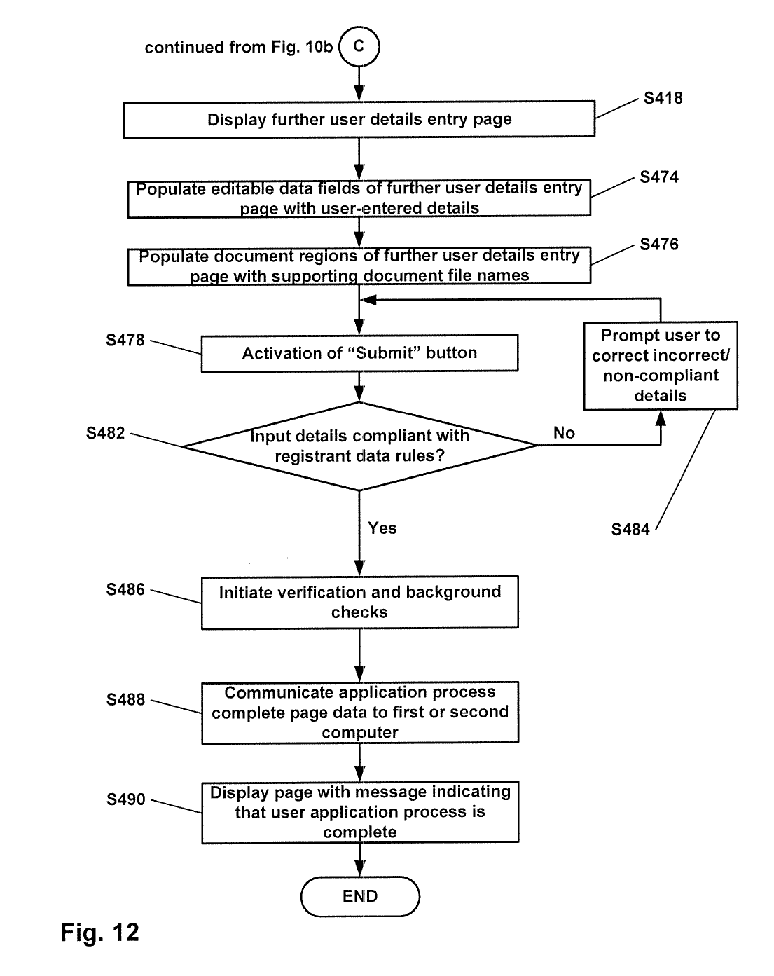

FIG. 12 schematically illustrates a process flow control diagram for a second part of the account-application process on a system in accordance with one or more embodiments of the present invention;

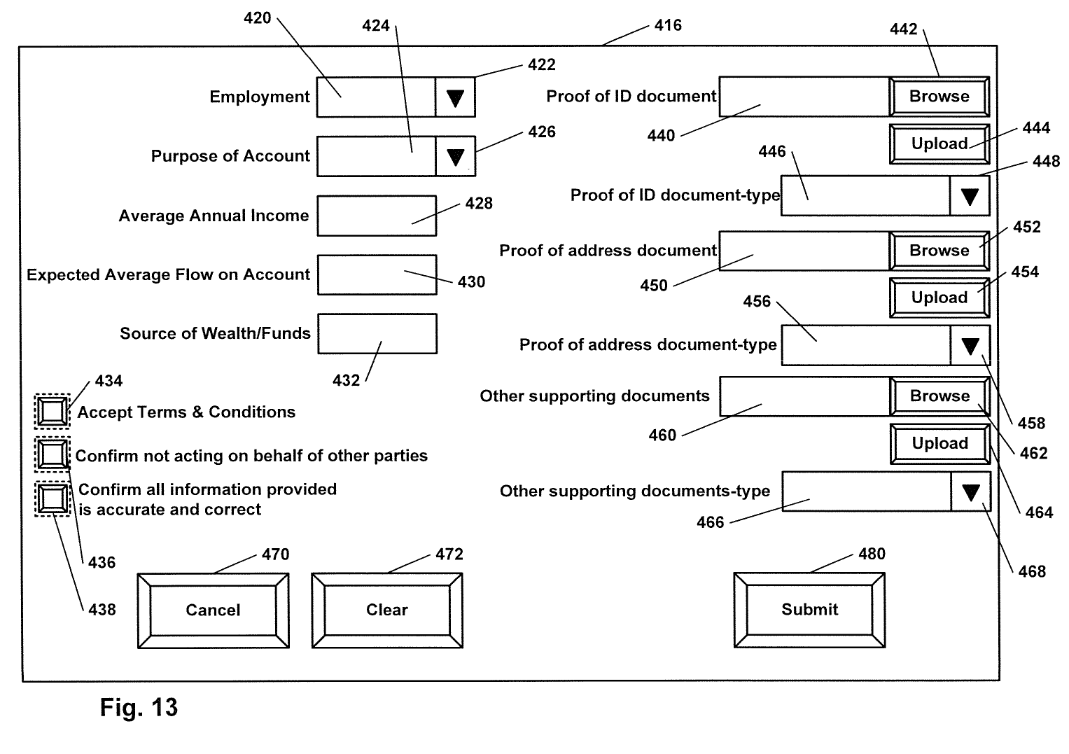

FIG. 13 schematically illustrates a user interface for entering details to be used in the second part of the account-application process on a system in accordance with one or more embodiments of the present invention;

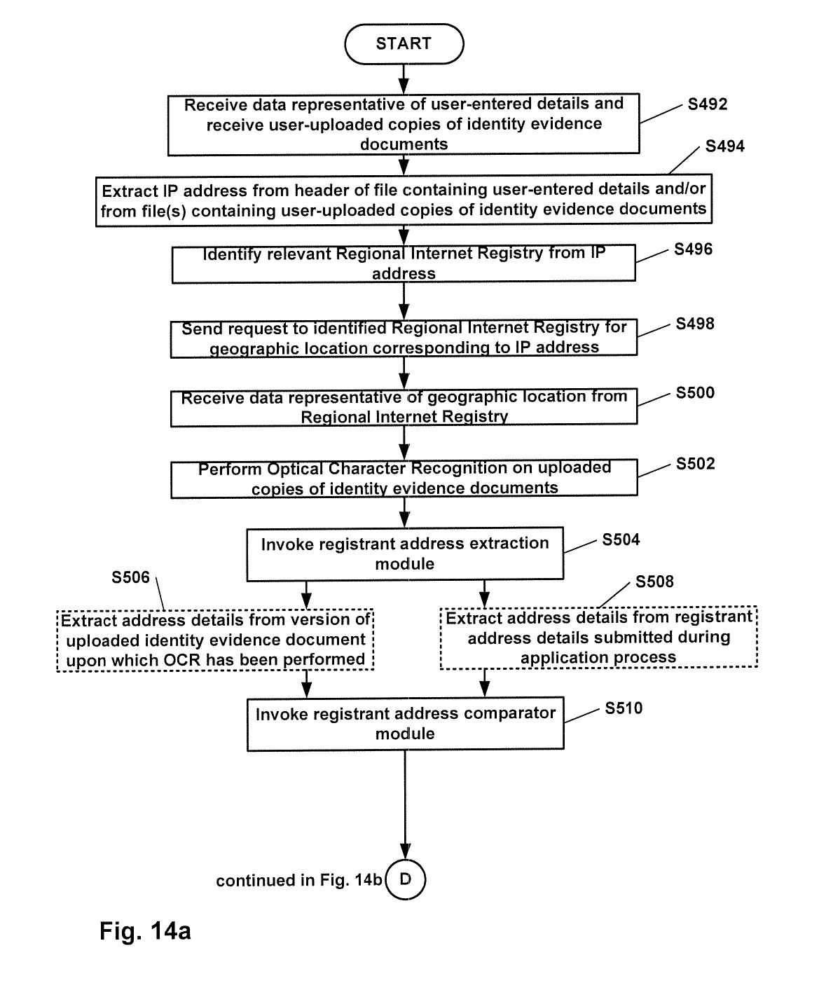

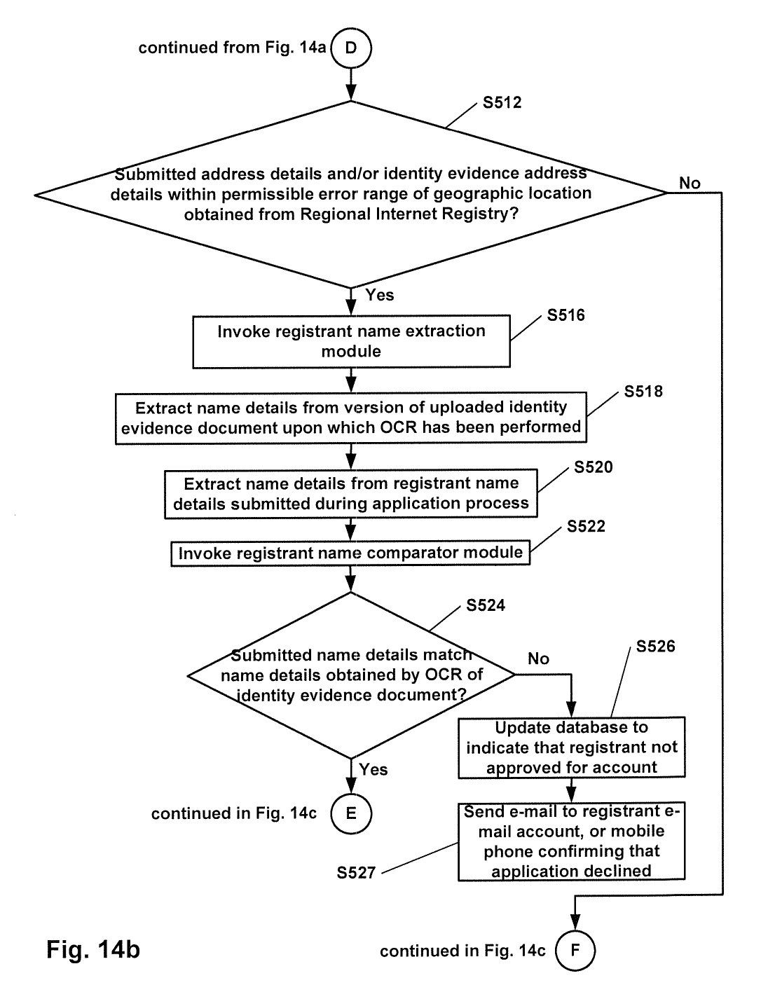

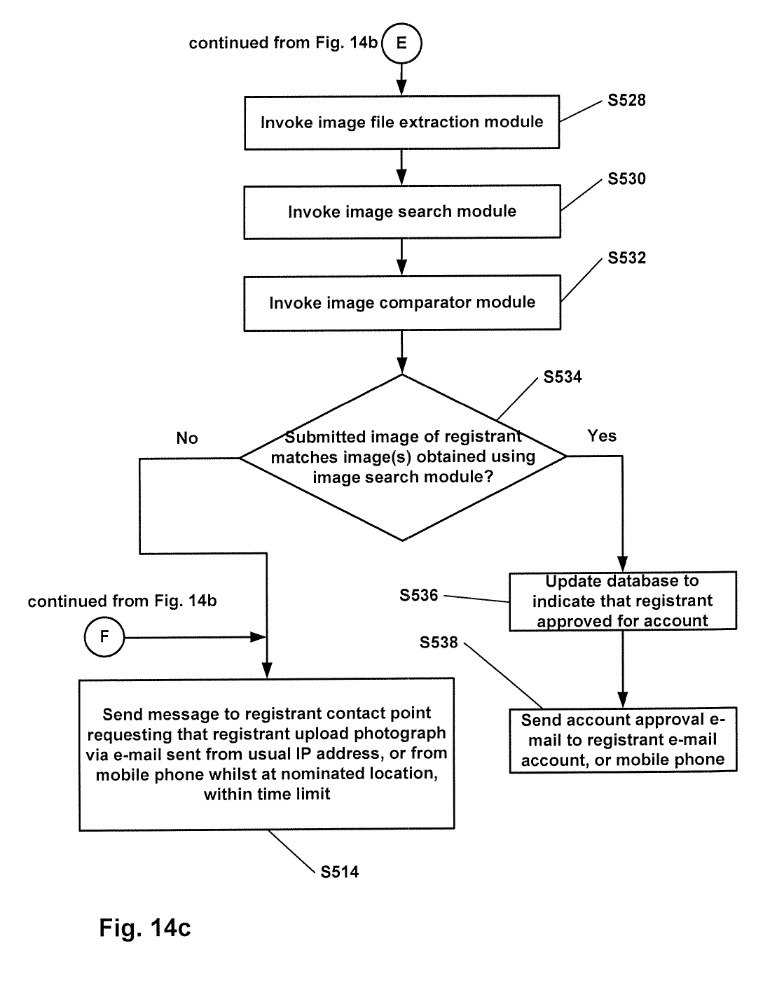

FIGS. 14a to 14c schematically illustrate a process flow control diagram for an account-application approval process on a system in accordance with one or more embodiments of the present invention;

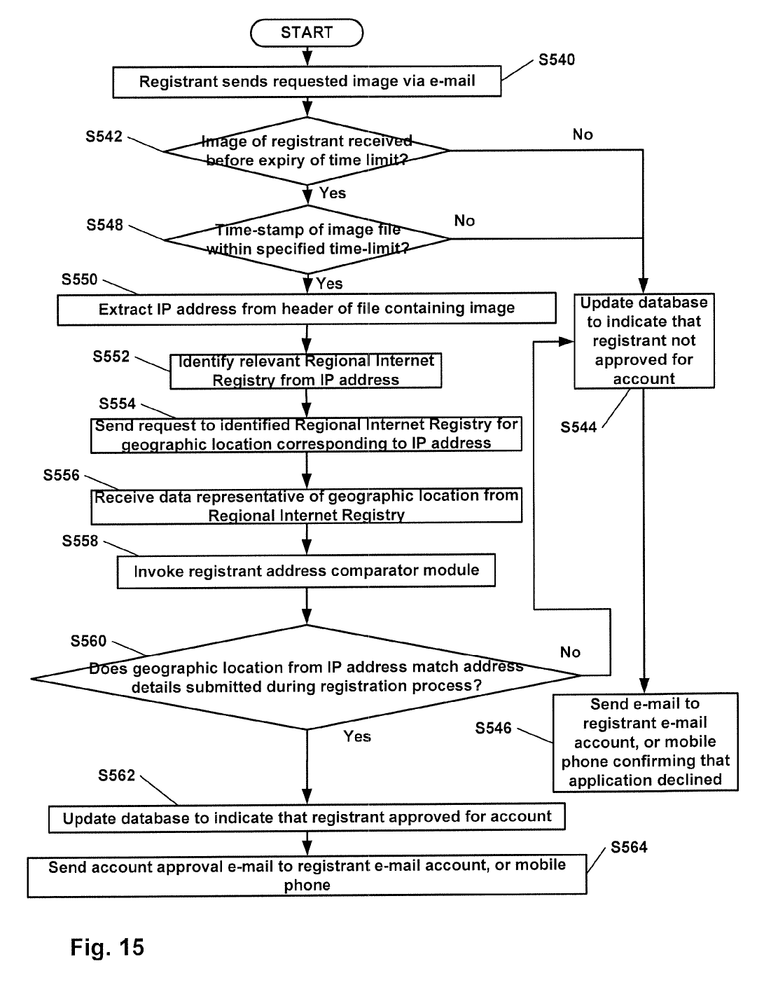

FIG. 15 schematically illustrates a process flow control diagram for an optional part of an account-application approval process on a system in accordance with one or more embodiments of the present invention; and

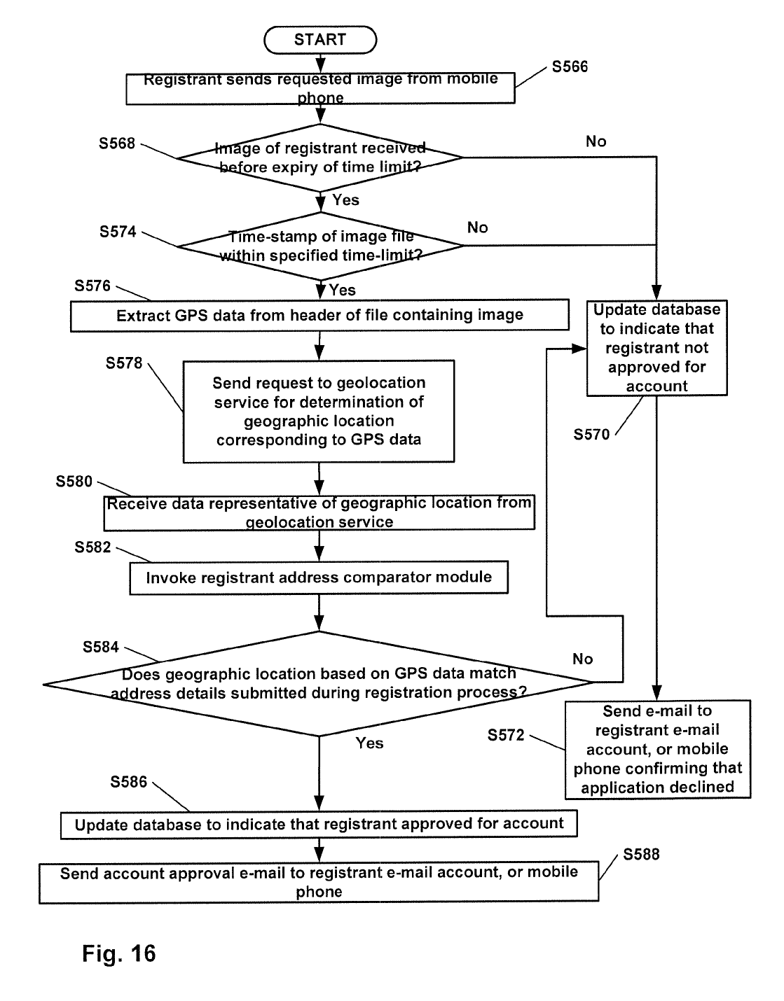

FIG. 16 schematically illustrates a process flow control diagram for an optional part of an account-application approval process on a system in accordance with one or more embodiments of the present invention.

An overview of a system comprising an apparatus in accordance with one or more embodiments of the present invention will now be described with reference to FIG. 1.

The system 100 comprises a first computer 102A, a second computer 102B, i.e. communications terminals, a cluster of servers 104, a data store 106, a communications provider 108 and a regional internet registry 110. The first computer 102A and second computer 102B arc configured to communicate with the cluster of servers 104 and the data store 106 using a communications network 112 (for example, the internet and/or another communications medium or system).

The first and second computers 102A and 102B each comprise a processor 114A and 114B which is operative to execute program code to configure the processors to implement an application program 116A and 116B and a web browser 118A and 118B. One, or both, computers 102A and 102B may be, for example, a mobile computing device such as a smartphone, a tablet or a laptop computer, or a desktop computer. Any other type of computing device that can communicate with the cluster of servers 104 may also be used. One, or both, computers 102A and 102B will generally communicate wirelessly with an internet or other communications access point in order to communicate with the cluster of servers 104 but other types of communications medium such as, for example, fibre optic or twisted-pair copper wire, may be used without stepping outside of the scope of the subject matter disclosed herein.

The application programs 116A and 116B comprise routines which, when executed on the first and second computers 102A and 102B, provide an interface through which output may be provided to a user and a user can enter input to system 100.

The Regional Internet Registry 110 comprises one or more organisations that administer and register Internet Protocol (IP) address space and Autonomous System (AS) numbers within a defined region.

The architecture of cluster of servers 104 is schematically illustrated in FIG. 2 and comprises a web server 120 operative to communicate with the web interface 122 and/or SMS interface 123 to allow for communication between the first and second computers 102A and 102B and the cluster of servers 104, and with the API interface 124 to receive requests from and send requests to the data store 106. The cluster of servers 104 also comprises an application server 126 operative to execute instructions responsive to requests from the web server 120 and to call a library of Application Program Interfaces (APIs) through API interface 124, and a database server 128 including a Database Management System (DMS) 130 operative to control the organisation, storage, retrieval, security and integrity of the data in a database 132. The DMS 130 is further operative to edit and store data in the database 132 responsive to a request from the application server 126. The application server 126 and the database server 128 are each operative to retrieve data from storage 136. Database server 128 also comprises a database interface 138 for communicating between the database server 128 and application server 126, for example. Data storage 136 may include data stored as part of database 132, i.e. a relational database, and also data structured in flat file format accessed directly by application server 126.

Although FIG. 2 illustrates storage 136 within the cluster of servers 104, storage 136 may reside outside the cluster of servers and/or be a part of any one or other of the servers comprising the cluster of servers 104.

The application server 126 is operative to respond to requests from the web server 120 and the database server 128 via an application interface 140. The application server 126 comprises a processor 142 operative to execute instructions for a plurality of modules 144 each of which relate to an aspect of the functionality of the application programs 116A and 116B. The application server 126 is operative to call upon an API library through API interface 124 comprising a collection of APIs to enable requests to be made to a communications provider 108 and to a data store 106. The API interface 124 forms a communications layer between the cluster of servers 104 and third parties that provide data to the system 100 illustrated in FIG. 1.

The web server 120 is operative to configure and deliver content to computers 102A and 102B in the form of dynamically generated web documents for display at the first computer 102A and/or the second computer 102B. The web documents may comprise user input regions operative to receive user input at the computers 102A and 102B and may also comprise text output. The web documents may also comprise multiple frames to accommodate frames corresponding to different content sources within the document such as documents and images. Some of the web documents may be stored in template form in storage 136. The template of a web document may include text fields and input regions to be configured by the web server.

The database server 128 is operative to execute instructions for routines forming the database management system (DMS) 130 for database 132. The DMS 130 is operative to control the organisation, storage, retrieval, security and integrity of the data in the database 132. The DMS 130 is further operative to edit and store data in the database 132 responsive to a request from the application server 126.

The data store 106 is operative to receive a request from the cluster of servers 104 either using an API 117 or with a direct response to the cluster of servers 104. The data store 106 comprises storage 119 where items are stored. The API 117 of data store 106 may provide access to a number of data store 106 services for managing data stored in the data store 106, controlling access thereto and communicating requests and data between the data store 106 and a requesting API, such as an API of the cluster of servers 104. The data store 106, responsive to receiving the request from the cluster of servers 104, is operative to respond to the request using an API 117 for communications with the cluster of servers 104.

The communications provider 108 is operative to receive a request from the API of cluster of servers 104 and to generate a communication in response to receiving that request, record details concerning the communication and transmit those details back to the cluster of servers 104. The communications provider 108 may provide, for example, email services, telephone services or instant messaging services.

FIG. 3 illustrates the application server 126 of FIG. 2 in more detail. The processor 142 is operative to execute instructions to implement the following modules:
User interface module 145;
Registrant data rules module 146;
Registrant application status module 148;
Internet Protocol (IP) address extraction module 150;
Global Positioning System (GPS) data extraction module 151;
Optical Character Recognition (OCR) module 152;
Registrant address extraction module 154;
Registrant-submitted physical address extraction module 156;
Registrant address comparator module 158;
Registrant name extraction module 160;
Registrant-submitted name extraction module 162;
Registrant name comparator module 164;
Image file extraction module 166;
Image search module 168;
Image comparator module 170;
Submitted image validity module 171; and
Registrant risk assessment module 172.

These modules and their functions will be described in more detail later.

In the described one or more embodiments, prior to using the system 100, a user registers on the system to establish a presence in the system. A first part of a user-registration process on the system is described using the process flow control diagram illustrated in FIG. 4.

Initially, a user (or registrant) establishes a presence in the system 100 by registering on the database 132 through DMS 130. A user registering on the system establishes communication with the cluster of servers 104 and transmits their user data to the cluster of servers. The new user establishes communication with the server using a user interface displayed on the first or second computers 102A and 102B. The user interface may be generated by a web browser running on the first or second computers 102A and 102B or the application program 116A, 116B which may be downloaded from a generic application store.

Therefore, in a first step of a registration process, a main page is displayed S174. The main page of the user interface contains selectable links, the activation of which will invoke display of an initial registration page or a login page (i.e. for a previously registered user).

The processor 142 operates to determine which one of the selectable links is activated S176 based upon data received from the first or second computers 102A and 102B.

Responsive to receipt of data indicating activation of the link to invoke display of the initial registration page, the processor 142 executes instructions to implement the user interface module 145 to communicate initial registration page display data to the first or second computers 102A and 102B for display S178 via a display thereof. Likewise, responsive to receipt of data indicating activation of the link to invoke display of the login page, the processor 142 executes instructions to implement the user interface module 145 to communicate login page display data to the first or second computers 102A and 102B for display S180 via a display thereof.

In the initial registration page, there are displayed selectable links, the activation of which will invoke display of an individual (i.e. natural person) registration page or a business (i.e. legal person) registration page.

Again, the processor 142 operates to determine which one of the selectable links is activated S182 based upon data received from the first or second computers 102A and 102B.

Thus, responsive to receipt of data indicating activation of the link to invoke display of the individual registration page, the processor 142 executes instructions to implement the user interface module 145 to communicate individual registration page display data to the first or second computers 102A and 102B for display S184 via a display thereof. Likewise, responsive to receipt of data indicating activation of the link to invoke display of the business registration page, the processor 142 executes instructions to implement the user interface module 145 to communicate business registration page display data to the first or second computers 102A and 102B for display S186 via a display thereof.

An individual registration page 187 of the user interface displayed on the first or second computers 102A and 102B is illustrated in FIG. 5.

The user enters their details into input regions of the displayed individual registration page and the input regions are populated S186 with user-entered details. The user must enter the following details into respective input regions (see FIG. 5):
“Gender” into input region 188 (by selection from a drop-down list, the display of which is initiated by clicking on drop-down arrow 190);
“Title” into input region 192 (by selection from a drop-down list, the display of which is initiated by clicking on drop-down arrow 194);
“First Name” into input region 196;
“Middle Name” into input region 198;
“Last Name” into input region 200;
“Country” into input region 202 (by selection from a drop-down list, the display of which is initiated by clicking on drop-down arrow 204);
“Mobile Phone Number” into input region 206;
“Mobile Phone Number (Confirm)” into input region 208; and
“E-mail address” into input region 210.

Responsive to activation S212 of a user selectable link 214 entitled “SUBMIT”, data representative of the user-entered details is transmitted to the web server 120 via web interface 122, for transfer to processor 142, for action by registrant data rules module 146 implemented thereon, S216.

Responsive to receiving the data from the user computer 102A (or 102B) the processor 142 transmits a request to storage 136 for registrant data rules. Responsive to retrieval of the registrant data rules, data representative of the registrant data rules is returned to the processor 142 which, in implementing the registrant data rules module 146, determines S218 if the details input by the user are compliant with the system's registrant data rules. If they are not, the processor 142 causes a signal to be communicated to the user computer 102A (or 102B) to invoke display S220 of a prompt on the display of the user computer 102A (or 102B). The prompt invites the user to correct details which are incorrect or non-compliant.

If the user-input details are correct, the processor 142 is operative to cause an e-mail to be sent S222 to the user-entered e-mail address. The e-mail contains a selectable verification link which, when activated, causes an e-mail validation page to be displayed on the display of the user computer 102A (or 102B). In this regard, the processor 142 implements an activation module 147, which executes a routine to generate the selectable verification link.

The selectable verification link is transmitted to the web server 120 from the application server 126 with a request that the selectable verification link is included in an e-mail message to be sent from the web server 120, via Web interface 122, to the e-mail address of the user.

The e-mail validation page and the process for validation of user-entered e-mail address details will be described later in relation to FIGS. 6 and 7.

When a determination is made that user-input details are correct, the processor 142 is also operative to cause an activation code to be sent S224 via Short Message Service (SMS) to the user's mobile phone (as determined from the user-entered mobile phone number details). The mobile phone may comprise one of first or second computers 102A, 102B. In this regard, the processor 142 implements an activation module 147, which executes a routine to generate the activation code.

The activation code is transmitted to the web server 120 from the application server 126 with a request that the activation code is included in an activation message to be sent from the web server 120, via SMS interface 123, to the mobile phone (computer 102A or 102B). Responsive to receiving the activation message, processor 114A or 114B of the mobile phone (i.e. computer 102A or 102B) instructs an SMS program thereof to invoke display of the activation code.

At any time in the individual user registration process, the user has the option to cancel the process or clear any data entered into one or more of the input regions of individual registration page 187. A cancel operation is effected responsive to activation S226 of a user selectable link 228 entitled “CANCEL”. Likewise, a clear operation is effected upon activation S230 of a user selectable link 232 entitled “CLEAR”.

Specific registrant data rules which may be employed by the registrant data rules module 146 in one or more embodiments of the present invention may comprise one or more of the following:
First/Middle/Last Name - maximum character limit 50 each. Validity checks performed by the registrant data rules module 146 to ensure that no special or high ASCII characters or numbers are entered. The registrant data rules module 146 is operative to cause the processor 142 to transcribe specific country characters found in alphabets such as Swedish/German/Spanish etc. (ä, ö, ü, ø) according to the standards of the International Civil Aviation Organization (ICAO) as would be found in the machine-readable zone. For example, “Müller” becomes “Mueller”. . .
Mobile Phone Number—minimum character length 7 digits. The registrant data rules module 146 is operative to cause the processor 142 to perform checks on entered data to ensure that no alphabetical or special characters are entered.
Mobile Phone Number (Confirm)—same as above. The numbers must be identical. If they are not, prompt user to correct.
E-mail address—a free text field, max character length 90. The registrant data rules module 146 is operative to cause the processor 142 to perform checks to ensure that no special characters are entered and that @ sign is present.
The registrant data rules module 146 is operative to cause the processor 142 to perform a check of an e-mail domain of the entered e-mail address against a blacklist of unwelcome providers. The blacklist forms part of the registrant data rules stored in database 132. If the domain name matches one of those on the blacklist, the processor 142 causes a signal to be communicated to the user computer 102A (or 102B) to invoke display of a message indicating that the entered e-mail address is not valid (e.g. invalid e-mail provider).
The registrant data rules module 146 is operative to cause the processor 142 to perform a check of the e-mail domain of the entered e-mail address to determine if the domain has a mail exchanger (MX) record (i.e. it is an actual mail-server and not a fabricated address). If not, the processor 142 causes a signal to be communicated to the user computer 102A (or 102B) to invoke display of a message prompting the user to check and enter a correct address.

The validation of a user-entered e-mail address on the system is now described with reference to FIGS. 6 and 7. FIG. 6 illustrates the process flow control diagram for validation of the user e-mail account and mobile phone number on the system 100 and FIG. 7 illustrates a user interface 236 for entering a code to be used in the user e-mail account and mobile phone number validation process.

Responsive to user selection of the selectable verification link from the e-mail sent to the user's e-mail address, the first or second computer 102A, 102B transmits a request to the web server 120 for validation of the user's e-mail account. The processor 142 executes instructions to implement the user interface module 145 to communicate e-mail and mobile phone number validation page data to the first or second computers 102A and 102B for display S234 via a display thereof.

The e-mail address and mobile phone validation page 236 of the user interface displayed on the first or second computers 102A and 102B is illustrated in FIG. 7.

The e-mail address and mobile phone validation page 236 displays a message 238 confirming that the e-mail address has been validated and a prompt 240 requesting that the user input the activation code sent via SMS to their mobile phone.

The user enters the activation code into input region 242 of the displayed e-mail address and mobile phone validation page 236 and the input region 242 is populated S244 with user-entered activation code.

Responsive to activation S246 of a user selectable link 248 entitled “VALIDATE”, data representative of the user-entered activation code is transmitted S249 to the web server 120 via web interface 122, for onwards transfer to processor 142, for action by activation module 147 implemented thereon.

Responsive to receiving the activation code, the activation module 147 compares the activation code received from the web server 120 with the activation code that was transmitted to first or second computer 102A, 102B, step S250. If the activation code received from the web server 120 matches the activation code transmitted to the first or second computer 102A, 102B the activation module 147 then operates to determine S252 if the activation code has expired or not (by reference to lifetime data stored in storage 136). If the code has not expired, processor 142 executes instructions to implement the user interface module 145 to communicate login details creation page data to the first or second computers 102A and 102B for display S254 via a display thereof.

If the activation code received from the web server 120 does not match the activation code transmitted to the first or second computer 102A, 102B the activation module 147 then operates to increase an attempt counter by 1 (step S256) and determines S258 if an incorrect activation code has been entered previously (by reference to attempt data stored in storage 136). If it is a first attempt, and an incorrect code has been entered on the first attempt, then the processor 142 executes instructions to implement the user interface module 145 to communicate prompt data to the first or second computers 102A and 102B for display via a display thereof. The prompt data causes the e-mail and mobile phone number validation page to be updated to display S260 a prompt requesting that the user re-enter the activation code. If a determination is made that an incorrect code has been entered on a previous occasion, the activation module 147 then operates to determine S262 if the current attempt is, for example, the third unsuccessful attempt (again, by reference to attempt data stored in storage 136). If it is not, prompt data is again communicated to the first or second computers 102A and 102B to cause the e-mail and mobile phone number validation page to be updated to display S260 a prompt requesting that the user re-enter the activation code.

If a determination is made that an incorrect code is entered on the, for example, third attempt, the activation module 147 then operates to increase a regeneration counter by one (step S264) and determines S266 if the number of regenerations equals, for example, two (by reference to regeneration data stored in storage 136). If not, the processor 142 executes instructions to implement the user interface module 145 to communicate prompt data to the first or second computers 102A and 102B for display via a display thereof. The prompt data causes the e-mail and mobile phone number validation page to be updated to display S268 a prompt requesting that the user initiate regeneration of the activation code.

Responsive to activation S270 of a user selectable link 272 entitled “RESEND”, data representative of regeneration request is transmitted to the web server 120 via web interface 122, for onwards transfer to processor 142, for action by activation module 147 implemented thereon. A regenerated activation code is created in the manner already described above for creation of an activation code. Responsive to creation of the regenerated activation code, the regenerated code is sent S274 to the mobile phone in the manner as already described above.

If a determination is made that the number of regenerations equals, for example, two (by reference to regeneration data stored in storage 136) the processor 142 executes instructions to implement the user interface module 145 to communicate prompt data to the first or second computers 102A and 102B for display via a display thereof. The prompt data causes the e-mail and mobile phone number validation page to be updated to display S276 a prompt requesting that the user re-start the registration process.

If, in step S252 a determination is made that the code has expired, the process proceeds to already described step S268.

At any time in the e-mail and mobile phone validation process, the user has the option to cancel the process. A cancel operation is effected upon activation of a user selectable link 276 entitled “CANCEL”.

The lifetime of the e-mail link and activation code may be configurable. For example, the e-mail link may be valid for activation within 48 hours from being sent to the user's e-mail address and the activation code may, for example, be valid for 30 minutes from being sent to the user's mobile phone.

Optionally, the above-described e-mail and mobile phone validation process may include a check to determine if the e-mail link has expired (e.g. more than 48 hours have elapsed from being sent to attempted activation of the link). In this case, the registration process will have to be re-started.

A second part of the user-registration process on the system is described using the process flow control diagram illustrated in FIG. 8. FIG. 9a illustrates a user interface for display at the first or second computer 102A, 102B as part of this process. This part of the user-registration process allows the user to create a log-in name and password for account access purposes.

Responsive to successful validation of e-mail and entry of a correct, unexpired, activation code, processor 142 executes instructions to implement the user interface module 145 to communicate login details creation page data to the first or second computers 102A and 102B for display S254 via a display thereof.

The login details creation page 280 of the user interface displayed on the first or second computers 102A and 102B is illustrated in FIG. 9a.

The login details creation page 280 displays a number of input regions into which the user can enter requested information. Responsive to user entry of the requested information, the input regions are populated S278 with user-entered details. The user must enter the following details into respective input regions:
“Preferred username” into input region 282;
“Preferred password” into input region 284;
“Password (Confirm)” into input region 286;
“Memorable Word 1” into input region 290;
“Memorable Word 2” into input region 292;
“Security Number” into input region 294; and
“Security Number (Confirm)” into input region 296.

Responsive to activation S298 of a user selectable link 300 entitled “SUBMIT”, data representative of the user-entered details are transmitted S302 to the web server 120 via web interface 122, for transfer to processor 142, for action by registrant data rules module 146 implemented thereon.

Responsive to receiving the data from the user computer 102A (or 102B) the processor 142 transmits a request to storage 136 for registrant data rules. Responsive to retrieval of the registrant data rules, data representative of the registrant data rules is returned to the processor 142 which, in implementing the registrant data rules module 146, determines S304 if the details input by the user are compliant with the system's registrant data rules. If they are not, the processor 142 causes a signal to be communicated to the user computer 102A (or 102B) to invoke display S306 of a prompt on the display of the user computer 102A (or 102B). The prompt invites the user to correct details which are incorrect or non-compliant.

At any time in the login details creation process, the user has the option to cancel the process, clear any data entered into one or more of the input regions of login details creation page 280, and/or print any data entered into one or more of the input regions of login details creation page 280. A cancel operation is effected responsive to activation of user selectable link 308 entitled “CANCEL”. Likewise, a clear operation is effected upon activation of a user selectable link 310 entitled “CLEAR”. Similarly, a print operation is effected upon activation of a user selectable link 312 entitled “PRINT”.

If the user-input details are correct and/or compliant with the registrant data rules, the processor 142 is operative to save S314 the user login details to database 132. Additionally, processor 142 executes instructions to implement the user interface module 145 to communicate S316 page data to the first or second computers 102A and 102B. The web browser 118A, 118B of the first or second computer 102A, 102B uses the page data to invoke display S318 of a page 320 (see FIG. 9b) indicating that login details have been created successfully. The user has the option at this point to continue with the application process or log-off and log-in later to continue the application process. A continue operation is effected responsive to activation of a user selectable link 322 entitled “NEXT”. Likewise, a log-off operation is effected upon activation of a user selectable link 324 entitled “LOG-OFF”.

Processor 142 is operative to determine S326 which option has been selected and dependent upon the data received, either sends instructions to the first or second computer 102A, 102B to invoke display S328 of a next page in the application process (see FIGS. 10a and 10b), or to initiate S330 a log-out operation from the process. After being logged-out, the application process can be continued at a later time by submitting S332 the created log-in details via the user interface displayed on the first or second computer 102A, 102B. Responsive to a successful log-in, processor 142 invokes display S328 of the next page in the application process (see FIGS. 10a and 10b).

Specific registrant data rules which may be employed by the registrant data rules module 146 for the log-in details creation process in one or more embodiments of the present invention may comprise one or more of the following:
Preferred username—must not include any special characters, i.e. only alphanumeric characters are permissible.
Password—must satisfy complexity requirements. For example, one or the more of the following may apply:
   it must be a minimum length of eight characters;
   at least one character must be an upper-case character;
   at least one character must be a numeric character;
   at least one character must be a “special” character (e.g. “!”, “&”, etc.);
   sequences of numeric and/or letter characters may not be permitted; and
   it must not include the user name.
Password confirm—must match the password entered into input region 284. If not, the system is operative to initiate display of an error message on the first or second computer 102A, 102B.
Security number—may have similar rules as for Password.
Memorable Word 1 and 2—must not be the same.

Having described the user registration and login details creation processes, a first part of an account-application process will now be described with reference to FIGS. 10a, 10b and 11. FIGS. 10a and 10b illustrate a process flow control diagram for a first part of the account-application process on the system 100 and FIG. 11 schematically illustrates a user details entry page 334 for entering details to be used in the first part of the account-application process.

Responsive to activation of the link “NEXT” 322 in the previously displayed page, or to a successful log-in, processor 142 invokes display S328 of the user details entry page 334 for entering details to be used in the first part of the account-application process.

In the user details entry page 334, there is displayed a number of editable input regions into which the user can enter requested information. There is also displayed a number of non-editable regions in which previously entered details are displayed. Processor 142 is operative to retrieve from database 132 (step S336) user details which were entered in previous steps and populate the non-editable regions of the user details entry page 334. The user must enter the following details into respective editable input regions:
“Date of Birth” into input region 338;
“Place of Birth” into input region 340;
“Nationality” into input region 342;
“Marital Status” into input region 344;
“Gender” into input region 346;
“Floor/flat number” into input region 348;
“Street” into input region 350;
“City/Town” into input region 352;
“Postcode” into input region 354;
“Province/County” into input region 356; and
“Landline telephone number” into input region 358.

The non-editable regions comprise the following regions populated with previously entered information:
“Gender”, e.g. “Male”, in region 360;
“Title”, e.g. “Mr”, in region 362;
“First Name”, e.g. “John”, in region 364;
“Middle Name”, e.g. “Robert”, in region 366;
“Last Name”, e.g. “Smith”, in region 368;
“Country”, e.g. “UK”, in region 370;
“E-mail”, e.g. “johnsmith@xyz.com”, in region 372; and
“Mobile No.”, e.g. “+44 1234 567890” in region 374.

Responsive to user entry of the requested information in the editable input regions, the editable input regions are populated S376 with user-entered details.

Responsive to activation S378 of a user selectable link 380 entitled “CONTINUE”, data representative of the user-entered details are communicated to the web server 120 via web interface 122, for onwards transfer to processor 142 for action by registrant-submitted physical address extraction module 156 implemented thereon. Registrant-submitted physical address extraction module 156 operates to extract S382 address data input in regions 348, 350, 352, 354 and 356. The processor 142 implements S384 registrant data rules module 146 to operate on the extracted physical address details data.

Responsive to receiving the data from the user computer 102A (or 102B) the processor 142 transmits a request to storage 136 for registrant data rules. Responsive to retrieval of the registrant data rules, data representative of the registrant data rules is returned to the processor 142 which, in implementing the registrant data rules module 146, determines S386 if the extracted physical address details data is compliant with the system's address data rules. If it is not, the processor 142 causes a signal to be communicated to the user computer 102A (or 102B) to invoke display S388 of a prompt on the display of the user computer 102A (or 102B). The prompt invites the user to correct details which are incorrect or non-compliant.

At any time in the login details creation process, the user has the option to clear any data entered into one or more of the editable input regions of user details entry page 334. A clear operation is effected responsive to activation of user selectable link 390 entitled “CLEAR”.

If the user-submitted physical address details are correct and/or compliant with the address data rules, the processor 142 employs the registrant data rules module 146 to determine S392 if remaining user input details are correct and/or compliant with the system's registrant data rules. Again, if not, the processor 142 causes a signal to be communicated to the user computer 102A (or 102B) to invoke display S388 of the prompt on the display of the user computer 102A (or 102B). The prompt invites the user to correct details which are incorrect or non-compliant.

If both the user-submitted physical address details and the remaining user input details are correct and/or compliant with the system's address and registrant data rules, processor 142 sends a request to DMS 130 to interrogate the database 132 for a registered user with details corresponding to the details input in the process thus far. The DMS 130 queries S394 the database 132 for a registered user with details which match one or more of the details entered in the user details entry page 334. If no match is found, i.e. the DMS 130 returns a report responsive to the interrogation of the database 132 indicating that there is no registered user with details matching those entered, a user record is created in the database 132 and the user-entered details are saved in the database 132 as part of the user record, step S396. Subsequent steps for continuation of the account-application process for a second part of the account-application process will be described later in relation to FIGS. 12 and 13.

If the DMS 130 reports a match, the database server 128 issues a request to processor 142 to request input of an indication that the user has an account already. Responsive to receiving the request, the processor 142 formulates a request to be sent to the first or second computer 102A, 102B to invoke display S398 of a prompt requesting the user to provide input indicating if they have an account already or not.

Responsive to receipt of a response to the request, the processor 142 determines S400 if the indication is positive or negative, i.e. that the user does already have an account, or not.

If the determination is negative, i.e. the user indicates that they do not have an existing account, the processor 142 executes instructions to implement registrant application status module 148. The registrant application status module 148 operates S402 to set an account application status flag to “Duplicate” and a user record is created S396 in the database 132 (along with the associate account application status flag).

If the determination is positive, i.e. an indication is provided by the user that they have an existing account, the processor 142 formulates a request to be sent to the first or second computer 102A, 102B to invoke display S404 of a prompt offering an option to merge (or not) the details of the existing account with the current details under a single relationship, i.e. one user record.

Responsive to receipt of a response indicative of selection of a particular option, i.e. “Merge” or “Not Merge”, the processor 142 determines S406 which option is selected.

If a “Not Merge” option is selected, the processor 142 executes instructions to implement registrant application status module 148. The registrant application status module 148 operates S402 to set an account application status flag to “Duplicate” and a user record is created S396 in the database 132 (along with the associated account application status flag).

If a “Merge” option is selected, the processor 142 executes instructions to cause a signal to be communicated to the user computer 102A (or 102B) to invoke display S408 of a message prompting the user to input login and password details for the existing account.

Responsive to a determination S410 that a correct login and password have been entered at the first or second computer 102A, 102B, the processor 142 executes instructions to implement registrant application status module 148. The registrant application status module 148 operates S412 to set an account application status flag to “Merge” and the user details are saved S414 as part of the details of the existing account in the database 132.

Having described the first part of the account-application process, a second part of an account-application process will now be described with reference to FIGS. 12 and 13. FIG. 12 illustrates a process flow control diagram for a second part of the account-application process on the system 100 and FIG. 13 schematically illustrates a further user details entry page 416 for entering details to be used in the second part of the account-application process.

Responsive to completion of the first part of the account-application process, as described above, processor 142 invokes display S418 of the further user details entry page 416 for entering details to be used in the second part of the account-application process.

In the further user details entry page 416, there is displayed a number of input regions into which the user can enter requested information. The user must enter the following details into respective input regions:
“Employment” into input region 420 (by selection from a drop-down list, the display of which is initiated by clicking on drop-down arrow 422);
“Purpose of Account” into input region 424 (by selection from a drop-down list, the display of which is initiated by clicking on drop-down arrow 426);
“Average Annual Income” into input region 428;
“Expected Average Flow on Account” into input region 430; and
“Source of Wealth/Funds” into input region 432.

Also displayed in the further user details entry page 416 are HTML checkboxes with labels that can be clicked to turn the checkbox on/off (i.e. insert a tick or remove a tick in the checkbox).

A first checkbox 434 is associated with a clickable label entitled “Accept Terms & Conditions”. A second checkbox 436 is associated with a clickable label entitled “Confirm no acting on behalf of other parties”. A third checkbox 436 is associated with a clickable label entitled “Confirm all information provided is accurate and correct”.

Also displayed in the further user details entry page 416 are input regions which allow the user to browse for application supporting documentation (e.g. proof of ID, proof of address, etc.) and to upload such supporting documentation for attachment to a submission file to be sent when the user initiates a submit operation.

First document region 440 is configured for display of a file path corresponding to a current storage location being viewed by a user (i.e. responsive to activation of user selectable link 442 entitled “BROWSE”). Upon location of a desired document file (i.e. a document file containing an image of an ID document), the user can upload the file for submission. This occurs responsive to activation of user selectable link 444 entitled “UPLOAD”. The user can provide an indication of the ID document type in ID document region 446 by selection of an appropriate term from a drop-down list, the display of which is initiated by clicking on drop-down arrow 448.

Similarly, second document region 450 is configured for display of a file path corresponding to a current storage location being viewed by a user (i.e. responsive to activation of user selectable link 452 entitled “BROWSE”). Upon location of a desired document file (i.e. a document file containing an image of an address document), the user can upload the file for submission. This occurs responsive to activation of user selectable link 454 entitled “UPLOAD”. The user can provide an indication of the address document type in address document region 456 by selection of an appropriate term from a drop-down list, the display of which is initiated by clicking on drop-down arrow 458.

Further similarly, third document region 460 is configured for display of a file path corresponding to a current storage location being viewed by a user (i.e. responsive to activation of user selectable link 462 entitled “BROWSE”). Upon location of a desired document file (e.g. another document which is neither and ID document or address document), the user can upload the file for submission. This occurs responsive to activation of user selectable link 464 entitled “UPLOAD”. The user can provide an indication of the other document type in other document region 466 by selection of an appropriate term from a drop-down list, the display of which is initiated by clicking on drop-down arrow 468.

As with other pages as described above, the user has the option to cancel the process or clear any data entered into one or more of the input regions of further user details entry page 416. A cancel operation is effected responsive to activation of a user selectable link 470 entitled “CANCEL”. Likewise, a clear operation is effected upon activation of a user selectable link 472 entitled “CLEAR”.

Continuation of the application process, i.e. navigation from the further user details entry page 416 to display a next page in the process, can only occur if all details are completed, all checkboxes are checked, and all requested documentation has been uploaded/attached.

Responsive to user entry of the requested information in the editable input regions, the editable input regions are populated S474 with user-entered details. Responsive to user upload of the requested supporting documents, the document regions are populated S476 with respective file names of the uploaded supporting documents.

Responsive to activation S478 of a user selectable link 480 entitled “SUBMIT”, data representative of the user-entered further user details are communicated to the web server 120 via web interface 122, for onwards transfer to processor 142 for action by registrant data rules module 146 implemented thereon.

Responsive to receiving the data from the user computer 102A (or 102B) the processor 142 transmits a request to storage 136 for registrant data rules. Responsive to retrieval of the registrant data rules, data representative of the registrant data rules is returned to the processor 142 which, in implementing the registrant data rules module 146, determines S482 if the input details data is compliant with the system's registrant data rules. If it is not, the processor 142 causes a signal to be communicated to the user computer 102A (or 102B) to invoke display S484 of a prompt on the display of the user computer 102A (or 102B). The prompt invites the user to correct details which are incorrect or non-compliant.

If the user-input details are correct and/or compliant with the registrant data rules, the processor 142 is operative to initiate S486 verification and background checks and to execute instructions to implement the user interface module 145 to communicate S488 page data to the first or second computers 102A and 102B. The web browser 118A, 118B of the first or second computer 102A, 1028 uses the page data to invoke display S490 of a page indicating that the user application process is complete.

The document upload functionality may support options such as, for example:
Upload of multiple documents of the same type, i.e. front and back of the document, which in most cases will be two separate files.
Acceptable document formats may be PDF, JPEG, etc.
Upload of other supporting documents to establish the source of wealth/funds.

The verification and background checks of step S486 form part of the account-application approval process described further below with reference to FIGS. 14a to 14c.

Data representative of user submitted details in first and second parts of the application process and document files attached to a submission file (containing supporting documents) shall be referred to hereinafter, for convenience, as “submission data”.

Responsive to receipt S492 of submission data, processor 142 executes instructions to implement IP address extraction module 150. The IP address extraction module 150 operates S494 to extract data representative of an IP address from a header of a packet containing the submission data. Using the extracted IP address data, the processor 142 interrogates storage 136 to identify S496 a relevant Regional Internet Registry based upon the IP address data. A list of Regional Internet Registries and the relevant portions of IP addresses associated with those Registries is maintained in storage 136. It is this list which is queried to identify the relevant Regional Internet Registry.

When data relating to the relevant Regional Internet Registry is found, storage 136 returns a report to processor 142 identifying the relevant Regional Internet Registry. Responsive to receipt of the report, the processor 142 communicates a request S498 containing the extracted IP address to the web server 120 via web interface 122, for onwards transfer to the relevant Regional Internet Registry 110, via communications network 112. The request comprises a request for data representative of a geographic location corresponding to the extracted IP address.

Received data (S500) representative of the geographic location corresponding to the extracted IP address is routed to processor to be forwarded to storage 136 for retrieval later.

Processor 142 also executes instructions to implement optical character recognition module 152. Optical character recognition module 152 operates S502 to perform optical character recognition (OCR) on uploaded identity evidence documents (as retrieved from storage by the processor 142) to convert text parts of the image document files into machine readable format. Subsequent to performance of the OCR operation, processor 142 executes instructions to implement S504 registrant address extraction module 154.

Registrant address extraction module 154 operates to:
Extract S506 address details from a machine readable version of an uploaded identity evidence document created from the identity evidence document upon which OCR has been performed, hereinafter “identity evidence address details”; and/or
Extract S508 address details from registrant address details submitted during the application process, and as retrieved from database 132, hereinafter “user-submitted address details”.

Since either step may be optional, they are illustrated using dotted lines in FIG. 14a. If both steps take place in a particular one or more embodiments of the present invention, then they may take place in any order.

The identity evidence address details and user-submitted address details are saved to storage 136 for use later.

Processor 142 also executes instructions to implement S510 address comparator module 158.

With reference to FIG. 14b, address comparator module 158 initiates retrieval of data representative of the identity evidence address details and/or user-submitted address details from storage 136, along with retrieval of data representative of the geographic location corresponding to the extracted IP address. Address comparator module 158 performs a comparison S512 of the data representative of the identity evidence address details with the data representative of the geographic location corresponding to the extracted IP address, and/or performs a comparison of the data representative of the user-submitted address details with the data representative of the geographic location corresponding to the extracted IP address.

In response to a determination that the data representative of the identity evidence address details does not match the data representative of geographic location corresponding to the extracted IP address, and/or that the data representative of the user-submitted address details does not match the data representative of the geographic location corresponding to the extracted IP address, the processor 142 is operative to cause a message to be sent S514 (see FIG. 14c) to the user contact point (e.g. via e-mail to the user's e-mail address or SMS to the user's mobile phone) requesting that the user take a digital photograph of themselves at their home address (or other nominated location where they have been conducting the application process, e.g. a workplace). The user is also requested to submit an image file containing the photograph within a specified time-limit (e.g. 30 minutes), by sending the image file as, for example, an e-mail attachment from a computer using their usual IP address, or from a mobile phone whilst at a nominated location, e.g. home or work (see FIG. 14c). This additional evidence may be used for optional additional parts of the account-application approval process (described further in relation to FIG. 15 or 16).

In the present context, the term “matches” can include both two physical locations which are coincident and two physical locations which are not coincident, but separated by a distance which falls within an error margin permitted by the system.

Responsive to a determination that the data representative of the identity evidence address does match the data representative of the geographic location corresponding to the extracted IP address, and/or that the data representative of the user-submitted address details does match the data representative of the geographic location corresponding to the extracted IP address, the processor 142 executes instructions to implement S516 registrant name extraction module 160.

Registrant name extraction module 160 operates to:
Extract S518 name details from a machine readable version of an uploaded identity evidence document created from the identity evidence document upon which OCR has been performed, hereinafter “identity evidence name details”; and
Extract S520 name details from registrant name details submitted during the application process, and as retrieved from database 132, hereinafter “user-submitted name details”.

The identity evidence name details and user-submitted name details are saved to storage 136 for use later.

Processor 142 also executes instructions to implement S522 registrant name comparator module 164.

Registrant name comparator module 164 initiates retrieval of data representative of the identity evidence name details and user-submitted name details from storage 136 and performs a comparison S524 of the data representative of the identity evidence name details with the data representative of the user-submitted name details.

In response to a determination that the data representative of the identity evidence name details does not match the data representative of the user-submitted name details, the processor 142 communicates a request to DMS 130 to update S526 the user record in database 132 to indicate that the user is not approved for an account. Additionally, the processor 142 is operative to cause a message to be sent S527 to the user's contact point (e.g. via e-mail to the user's e-mail address or SMS to the user's mobile phone) to confirm that their application has been declined and that they have not been approved for an account.

However, if the data representative of the identity evidence name does match the data representative of the user-submitted name, the processor 142 executes instructions to implement S528 (see FIG. 14c) image file extraction module 166.

Image file extraction module 166 operates to extract a photographic image of the user from an uploaded identity evidence document.

The photographic image is saved to storage 136 for use later.

Processor 142 also executes instructions to implement S530 image search module 168 for carrying out an Internet search for photographic images of the user (e.g. using the user's names as search terms). Search results are saved to storage 136 for use later.

Processor 142 further executes instructions to implement S532 image comparator module 170.

Image comparator module 170 initiates retrieval of data representative of the photographic image and data representative of the images in the search results from storage 136 and performs a comparison S534 of the data representative of the photographic image with the data representative of the images in the search results.

In response to a determination that the data representative of the photographic image does not match the data representative of the images in the search results, the processor 142 is operative to cause a message to be sent S514 to the user contact point (e.g. via e-mail to the user's e-mail address or SMS to the user's mobile phone) requesting that the user take a photograph of themselves at their home address (or other nominated location where they have been conducting the application process, e.g. a workplace). The user is also requested to submit an image file containing the photograph within a specified time-limit (e.g. 30 minutes), by sending the image file as, for example, an e-mail attachment from a computer using their usual IP address, or from a mobile phone whilst at a nominated location, e.g. home or work. This additional evidence may be used for optional additional parts of the account-application approval process (described further in relation to FIG. 15 or 16).

However, responsive to a determination that the data representative of the photographic image does match the data representative of the images in the search results, the processor 142 communicates a request to DMS 130 to update S536 the user record in database 132 to indicate that the user is approved for an account. Additionally, the processor 142 is operative to cause a message to be sent S538 to the user's contact point (e.g. via e-mail to the user's e-mail address or SMS to the user's mobile phone) to confirm that their application has been successful and that they have been approved for an account.

FIGS. 15 and 16 illustrate process flow control diagrams for optional parts of the account-application approval process, which may be implemented where, in order to allow an approval decision to be made, further information is requested from the user. The steps of these optional parts occur subsequent to step S514 of FIG. 14c. FIG. 15 relates to a process where the further information is submitted by the user from a terminal connected to the system via a point having an IP address. FIG. 16 relates to a process where the further information is submitted by the user from a terminal connected to the system via a mobile phone cellular network.

In the optional process illustrated in FIG. 15, the user, responsive to the request of step 5514 of FIG. 14c, having taken a photograph of themselves using appropriate imaging equipment, initiates transmission of an e-mail (or other suitable file transfer mechanism) containing an image file comprising data representative of the photograph from first or second computer 102A, 102B. The image file is communicated S540 to the web server 120 via web interface 122, for onwards transfer to processor 142, for action by submitted image validity module 171 implemented thereon.

Responsive to receiving the image file, the submitted image validity module 171 operates to determine S542 if the image file is received within the specified time-limit by reference to timing data stored in storage 136. The timing data comprises data representative of a time at which e-mail of step S514 is sent. If the image file is not received within the specified time-limit, processor 142 communicates a request to DMS 130 to update S544 the user record in database 132 to indicate that the user is not approved for an account. Additionally, the processor 142 is operative to cause a message to be sent S546 to the user's contact point (e.g. via e-mail to the user's e-mail address or SMS to the user's mobile phone) to confirm that their application has been declined and that they have not been approved for an account.

However, if the image file is received within the specified time-limit, the submitted image validity module 171 operates to extract data representative of a time-stamp from the image file and, with reference to the timing data stored in storage 136, operates to compare the time-stamp data to the timing data to determine S548 if a time represented by the time-stamp data of the image file is after a time represented by the timing data. This is to determine if the photograph taken by the user of themselves occurred after the request of step S514 (i.e. to avoid out-of-date photographs being submitted). If the comparison of the time-stamp data of the image file to the timing data is indicative of the image file being created prior to the request of step S514, processor 142 communicates a request to DMS 130 to update S544 the user record in database 132 to indicate that the user is not approved for an account. Additionally, the processor 142 is operative to cause a message to be sent S546 to the user's contact point (e.g. via e-mail to the user's e-mail address or SMS to the user's mobile phone) to confirm that their application has been declined and that they have not been approved for an account.

If the comparison of the time-stamp data of the image file to the timing data is indicative of the image file being created after the request of step S514, processor 142 executes instructions to implement IP address extraction module 150. The IP address extraction module 150 operates S550 to extract data representative of an IP address from a header of a packet containing the image file. Using the extracted IP address data, the processor 142 interrogates storage 136 to identify S552 a relevant Regional Internet Registry based upon the IP address data. A list of Regional Internet Registries and the relevant portions of IP addresses associated with those Registries is maintained in storage 136. It is this list which is queried to identify the relevant Regional Internet Registry.

When data relating to the relevant Regional Internet Registry is found, storage 136 returns a report to processor 142 identifying the relevant Regional Internet Registry. Responsive to receipt of the report, the processor 142 communicates a request S554 containing the extracted IP address to the web server 120 via web interface 122, for onwards transfer to the relevant Regional Internet Registry 110, via communications network 112. The request comprises a request for data representative of a geographic location corresponding to the extracted IP address.

Received data (S556) representative of the geographic location corresponding to the extracted IP address is routed to processor 142 to be forwarded to storage 136 for retrieval later.

Subsequent to receipt of the data representative of the geographic location processor 142 executes instructions to implement S558 address comparator module 158.

Address comparator module 158 initiates retrieval of data representative of the user-submitted address details from storage 136, along with retrieval of data representative of the geographic location corresponding to the extracted IP address. Address comparator module 158 performs a comparison S560 of the data representative of the user-submitted address details with the data representative of the geographic location corresponding to the extracted IP address.

In response to a determination that the data representative of the user-submitted address does not match the data representative of the geographic location corresponding to the extracted IP address, processor 142 communicates a request to DMS 130 to update S544 the user record in database 132 to indicate that the user is not approved for an account. Additionally, the processor 142 is operative to cause a message to be sent S546 to the user's contact point (e.g. via e-mail to the user's e-mail address or SMS to the user's mobile phone) to confirm that their application has been declined and that they have not been approved for an account.

However, responsive to a determination that the data representative of the user-submitted address does match the data representative of the geographic location corresponding to the extracted IP address, processor 142 communicates a request to DMS 130 to update S562 the user record in database 132 to indicate that the user is approved for an account. Additionally, the processor 142 is operative to cause a message to be sent S564 to the user's contact point (e.g. via e-mail to the user's e-mail address or SMS to the user's mobile phone) to confirm that their application has been successful and that they have been approved for an account.

In the optional process illustrated in FIG. 16, the user, responsive to the request of step S514 of FIG. 14c, having taken a photograph of themselves using appropriate imaging equipment, initiates transmission from their mobile phone of an image file comprising data representative of the photograph. The image file is communicated S566 to the web server 120 via web interface 122, for onwards transfer to processor 142, for action by submitted image validity module 171 implemented thereon.

The imaging equipment may be, for example, a global positioning enabled camera, which may comprise a feature of the user's mobile phone.

Responsive to receiving the image file, the submitted image validity module 171 operates to determine S568 if the image file is received within the specified time-limit by reference to timing data stored in storage 136. The timing data comprises data representative of a time at which e-mail of step S514 is sent. If the image file is not received within the specified time-limit, processor 142 communicates a request to DMS 130 to update S570 the user record in database 132 to indicate that the user is not approved for an account. Additionally, the processor 142 is operative to cause a message to be sent S572 to the user's contact point (e.g. via e-mail to the user's e-mail address or SMS to the user's mobile phone) to confirm that their application has been declined and that they have not been approved for an account.

However, if the image file is received within the specified time-limit, the submitted image validity module 171 operates to extract data representative of a time-stamp from the image file and, with reference to the timing data stored in storage 136, operates to compare the time-stamp data to the timing data to determine S574 if a time represented by the time-stamp data of the image file is after a time represented by the timing data. This is to determine if the photograph taken by the user of themselves occurred after the request of step S514 (i.e. to avoid out-of-date photographs being submitted). If the comparison of the time-stamp data of the image file to the timing data is indicative of the image file being created prior to the request of step S514, processor 142 communicates a request to DMS 130 to update S570 the user record in database 132 to indicate that the user is not approved for an account. Additionally, the processor 142 is operative to cause a message to be sent S572 to the user's contact point (e.g. via e-mail to the user's e-mail address or SMS to the user's mobile phone) to confirm that their application has been declined and that they have not been approved for an account.

If the comparison of the time-stamp data of the image file to the timing data is indicative of the image file being created after the request of step S514, processor 142 executes instructions to implement GPS data extraction module 151. The GPS data extraction module 151 operates S576 to extract GPS data from a header of a packet containing the image file. Using the extracted GPS data, the processor 142 communicates a request S578 to a geolocation service for a geographic location corresponding to the extracted GPS data.

Received data (S580) representative of the geographic location corresponding to the GPS data is routed to processor 142 to be forwarded to storage 136 for retrieval later.

Subsequent to receipt of the data representative of the geographic location, processor 142 executes instructions to implement S582 address comparator module 158.

Address comparator module 158 initiates retrieval of data representative of the user-submitted address details from storage 136, along with retrieval of data representative of the geographic location corresponding to the extracted GPS data. Address comparator module 158 performs a comparison S584 of the data representative of the user-submitted address details with the data representative of the geographic location corresponding to the extracted GPS data.

In response to a determination that the data representative of the user-submitted address does not match the data representative of the geographic location corresponding to the extracted GPS data, processor 142 communicates a request to DMS 130 to update S570 the user record in database 132 to indicate that the user is not approved for an account. Additionally, the processor 142 is operative to cause a message to be sent S572 to the user's contact point (e.g. via e-mail to the user's e-mail address or SMS to the user's mobile phone) to confirm that their application has been declined and that they have not been approved for an account.

However, responsive to a determination that the data representative of the user-submitted address does match the data representative of the geographic location corresponding to the extracted GPS data, processor 142 communicates a request to DMS 130 to update S586 the user record in database 132 to indicate that the user is approved for an account. Additionally, the processor 142 is operative to cause a message to be sent S588 to the user's contact point (e.g. via e-mail to the user's e-mail address or SMS to the user's mobile phone) to confirm that their application has been successful and that they have been approved for an account.

In one or more optional arrangements, certain steps of the account-application approval process (as described above with reference to FIGS. 14a to 14c) may be excluded. For example, the account-application approval process may be based on one or more, but not all, of:
address comparison (i.e. comparison of submitted address details with geographic location obtained via IP address, and/or comparison of address details obtained from submitted identity evidence with geographic location obtained via IP address);
image comparison (i.e. comparison of an image obtained from submitted identity evidence with an image obtained using image search module); and
name comparison (i.e. comparison of submitted name details with name details obtained from submitted identity evidence).

In one or more optional arrangements the address comparison stage of the account-application approval process does not utilise IP address data but instead requests a user to submit GPS data within a specified time-limit via the computer, 102A/102B they are using for the account-application approval process. In a particular embodiment the request is for a digital photograph from a GPS enabled camera. Such a GPS enabled camera may be found in a mobile phone as well as in a standalone camera. The process for address comparison where the IP data is not used may follow the process described above with reference to FIG. 16 although the image file is downloaded to the computer 102A/102B rather than sent from the mobile phone. The mobile phone of FIG. 16 may be replaced with another GPS enabled device such as a GPS enabled camera or just a GPS location apparatus and the digital image file or just GPS data file as appropriate submitted via the computer 102A/103B. Such an embodiment is appropriate for a region where the IP address of a computer does not have a correspondence with a particular geographic location and is not an optional process for address comparison but the process for address comparison.

In these one or more optional arrangement a determination of the physical location where the user is undertaking the application process is made based upon GPS data instead of (or in addition to IP address data). Thus, with particular reference to FIG. 14a, responsive to receipt of submission data, processor 142 executes instructions to implement GPS data extraction module 151. The GPS data extraction module 150 operates to extract data representative of a GPS location from a header of a packet containing the submission data. Using the extracted GPS location data, the processor 142 interrogates storage 136 to identify a geographic location based upon the GPS location data.

Data representative of the geographic location corresponding to the extracted GPS data is routed to processor to be forwarded to storage 136 for retrieval later. This GPS-based geographic location data is used in process steps corresponding to step S510 of FIG. 14a and a step similar to step S512 of FIG. 14b.

In one or more optional arrangements, the account-application approval process (as described above with reference to FIGS. 14a to 14c, and including the one or more optional arrangements described above), may be supplemented further by steps in which image comparator module 170 operates to perform a comparison of data representative of the photographic image extracted from the user-submitted identity evidence with data representative of a separate photographic image submitted by the user (e.g. the image provided in step S540 of FIG. 15 or step S566 of FIG. 16). If no match is determined, the application may be declined, but if a match is determined, the application may be approved.

In one or more optional arrangements, the account-application approval process (as described above with reference to FIGS. 14a to 14c, and including the one or more optional arrangements described above), may be supplemented further by steps in which processor 142 executes instructions to implement registrant risk assessment module 172. This module operates to create a risk-score for the registrant based upon information supplied during the application process. For example, the risk-score can be influenced by one or more of:
country of residence of the registrant;
country of origin of the registrant;
whether or not the registrant is a politically exposed person (PEP); and
whether or not the registrant is listed in a credit “blacklist”.

The risk-score assigned to the individual can be stored with the user details in database 132.

The above description relates to the application process for users who are natural persons, i.e. real human beings. However, the application process can be used for account applications for users who are legal persons, i.e. a business entity (private legal person) or a government entity (public legal person). It should be appreciated that requested information for legal persons may differ from requested information for natural persons and/or additional information may be required. However, this would simply involve the display of webpages relevant to a business application as opposed to those relevant to an application by an individual. Examples of information that may be requested from a business are as follows:
Company name
Trading name
Indication of company type status (e.g. Sole Trader, Limited Partnership, Limited Liability Partnership, Limited Liability Company, Partnership, Private Company Limited by Guarantee, Unlimited Company, Trust, Public Stock Company, Other)
Website
Address
   House/Building/Floor no.
   Street1
   Street2
   Postcode
   City
   County
   Country
Postal address (if different)
   House/Building/Floor no.
   Street
   Street2
   Postcode
   City
   County
   Country
Registration Number
Country of Incorporation
Incorporation Date
Date when trading commenced
Description of business activity
   Description of suppliers
   Countries where suppliers are based
   Description of customers
   Countries where customers are based
Indication if member of Trade body/association
   Name of body/association
   Registration number
Account usage Purpose
Expected flow per annum
Expected flow per month
If regulated activity
   Name of regulator
   Registration number
Past activity
   Year
   Start month
   End month
   Turnover
   Net profit
Signatory information
   Login data
   Title
   Name
   Middle Name
   Surname
   Mobile phone number
   e-mail address
   Gender (male, female)
   Date of birth
   Previous names
   Country of birth
   Nationality of Birth
   Nationality
   Country
   Passport No
   Validity date
   Marital status
   Country of residence
   Residence address

For an application by legal persons such as a business, the account application process as described above in relation to an individual may be used for those individuals of the business who will be account signatories. Therefore, they may be required to provide identity evidence in the same manner as described above, and such identity evidence will be verified in the same manner as described above.

In the above-described one or more embodiments, a password for user log-in is created by the user. However in optional arrangements, a password can be created by the application server and provided to the user.

In one or more optional arrangements, an application program 116a, 116b on one of said first or second computers 102A, 102B may comprise a program downloadable to the first or second computer 102A, 102B from the cluster of servers 104, or from data store 106. The program, when executed on the first or second computer 102A, 102B can configure the first or second computer 102A, 102B to display, via a display thereof, a user interface for allowing a user to enter information to undertake the application process, i.e. a “client-hosted session” as opposed to a web-browser session. In this optional arrangement, the application program 116A or 116B may employ an encryption algorithm to ensure that data representative of information submitted by the user cannot be altered or tampered with prior to submission to the cluster of servers 104. This may prevent alteration of, for example, date and time data for identity evidence to be submitted, and date, location and time data of a photograph taken by the user of themselves using, for example, a global positioning enabled camera.

It is to be understood that any feature described in relation to any one embodiment may be used alone, or in combination with other features described, and may also be used in combination with one or more features of any other of the embodiments, or any combination of any other of the embodiments. For example, the OCR feature need not be implemented but the data copied from documents supplied to the data processing application but by a clerk.

As used herein any reference to “one embodiment” or “an embodiment” means that a particular element, feature, structure, or characteristic described in connection with the embodiment is included in at least one embodiment. The appearances of the phrase “in one embodiment” or the phrase in “in an embodiment” in various places in the specification are not necessarily referring to the same embodiment.

Insofar as embodiments of the invention described above are implementable, at least in part, using a software-controlled programmable processing device such as a general purpose processor or special-purpose processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual Basic, ActiveX, assembly language, machine code and so forth. A skilled person would readily understand that term “computer” in its most general sense encompasses programmable devices such as referred to above, and data processing apparatus and computer systems in whatever format they may arise, for example, desktop personal computer, laptop personal computer, tablet, smart phone or other computing device.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), optical disk, magnetic media, magneto-optical media, removable memory cards or disks, various types of Digital Versatile Disk (DVD) subscriber identity module, tape, cassette solid-state memory. The computer program may be supplied from a remote source embodied in the communications medium such as an electronic signal, radio frequency carrier wave or optical carrier waves. Such carrier media are also envisaged as aspects of the present invention.

As used herein, the terms “comprises”, “comprising”, “includes”, “including”, “has”, having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. For example, server cluster 104 may not comprise servers geographically close to each other but one or more servers may be geographically remote from each other.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

1. A data processing apparatus operative to automatically verify meta data of a natural or legal person submitted to the data processing apparatus, the data processing apparatus configured to:
establish a communications session with a communications terminal through a first communications system;
receive from the communications terminal first address data defining a geographic location for the communications terminal;
derive a first geographic location for the communications terminal from the first address data; and
compare the first geographic location with a street address supplied to the data processing apparatus for the natural or legal person to determine a first geographic correspondence between the first geographic location and the street address.

2. A data processing apparatus according to claim 1, wherein the first geographic correspondence comprises a measure of geographic proximity between the first geographic location and the street address.

3. A data processing apparatus according to claim I or 2, further configured to determine if the first geographic correspondence satisfies a first geographic criterion.

4. A data processing apparatus according to claim 3, further configured to indicate a first positive verification of the street address for the first geographic correspondence satisfying the first geographic criterion.

5. A data processing apparatus according to claim 3 or 4, wherein the first geographic criterion comprises the first geographic location and street address being within a predefined distance of each other.

6. A data processing apparatus according to any preceding claim, wherein the first geographic location comprises a geographic locality.

7. A data processing apparatus according to any preceding claim, wherein the first address data is supplied from geolocation apparatus and is indicative of the geographic location of the geolocation apparatus.

8. A data processing apparatus according to any of claims 1 to 6, wherein the first address data is address data assigned to a communications origination point for the communications terminal by the first communications system.

9. A data processing apparatus according to claim 8, further configured to:
provide a message for presentation through a user interface of the communications terminal requesting input of second address data assigned by a second communications system to geolocation apparatus indicative of the geographic location of the geolocation apparatus;
receive the second address data and determine a second geographic location corresponding to the geographic location of the geolocation apparatus from the second address data; and
compare the street address with the second geographic location to determine a second geographic correspondence between the street address and second geographic location.

10. A data processing apparatus according to claim 9, wherein the second geographic correspondence comprises a measure of geographic proximity between the second geographic location and the street address.

11. A data processing apparatus according to claim 9 or 10, further configured to determine if the second geographic correspondence satisfies a second geographic criterion.

12. A data processing apparatus according to claim 11, further configured to indicate a second positive verification of the street address for the second geographic correspondence satisfying the second geographic condition.

13. A data processing apparatus according to claim 11 or 12, wherein the second geographic criterion comprises the second geographic location and street address being within a predefined distance of each other.

14. A data processing apparatus according to any of claims 9 to 13, further configured such that the second geographic correspondence and/or the second geographic criterion are the same as respective first geographic correspondence and first geographic criterion.

15. A data processing apparatus according to any preceding claim, wherein the geolocation apparatus is configured to receive signals from a satellite system for determining global position of the geolocation apparatus.

16. A data processing apparatus according to claim 15 dependent on any of claims 9 to 14, wherein the second address data is supplied from the geolocation apparatus and is indicative of the geographic location of the geolocation apparatus.

17. A data processing apparatus according to any of claims 9 to 16, wherein the second address data further comprises a time stamp corresponding to when the second address data was instantiated, the data processing apparatus further configured to:
compare the time stamp with the time the message was provided for presentation on the user interface; and
determine a time difference between the time indicated by the time stamp and the time the message was provided.

18. A data processing apparatus according to claim 17, further configured to indicate a third positive verification of the street address for the time difference being less than a predefined time period.

19. A data processing apparatus according to any of claims 9 to 18, wherein the geolocation apparatus comprises a camera and the second address data is included with an image file corresponding to an image captured by the camera.

20. A data processing apparatus according to claim 19, further configured to:
initiate a search of one or more databases for one or more images corresponding to the location defined by the second address;
compare at least one of the one or more images with the captured image to determine a level of correspondence therebetween; and
indicate a fourth positive verification of the street address for the level of correspondence being sufficiently great.

21. A data processing apparatus according to claim 19 or 20, further configured to:
provide in the message a request for an image of the natural person engaging in the communications session;
initiate a search of one or more databases for one or more images corresponding to the name of the natural person;
compare at least one of the one or more images with the image to determine a level of correspondence therebetween; and
indicate a fifth positive verification of the identity of the natural person for the level of correspondence being sufficiently great.

22. A data processing apparatus according to any of claims 1 to 18, further configured to:
provide a personal image request message requesting an image of the natural person engaging in the communications session;
initiate a search of one or more databases for one or more images corresponding to the name of the natural person;
compare at least one of the one or more images with the image to determine a level of correspondence therebetween; and
indicate a sixth positive verification of the identity of the natural person for the level of correspondence being sufficiently great.

23. A data processing apparatus according to claim 20, further configured to establish a confirmed positive verification of the street address based on one or more of the first, second, third or fourth positive verification.

24. A data processing apparatus according to claim 21 or 22, further configured to establish a confirmed positive verification of the natural person based on the fifth or sixth positive verification.

25. A communications terminal operative for receiving input of meta data of a natural of legal person, the communications terminal configured to:
establish a communications session with a data processing apparatus through a first communications system;
encrypt first address data defining a geographic location for the communications terminal;
transmit encrypted first address data to the data processing apparatus.

26. A communications terminal according to claim 25, further configured to:
encrypt input meta data of a natural or legal person;
transmit encrypted input meta data of the natural or legal person to the data processing apparatus.

27. A communications terminal according to claim 25 or 26, wherein said first address data defines a geographic location for the communications terminal.

28. A communications terminal according to any of claims 25 to 27, wherein the first address data further comprises a first time stamp corresponding to when the first address data was instantiated, the communications terminal further configured to:
encrypt the first time stamp; and
transmit encrypted first time stamp data to the data processing apparatus.

29. A communications terminal according to any of claims 25 to 28, wherein the first address data is supplied from geolocation apparatus and is indicative of the geographic location of the geolocation apparatus.

30. A communications terminal according to any of claims 25 to 29, wherein the first address data is address data assigned to a communications origination point for the communications terminal by the first communications system.

31. A communications terminal according to claim 30, further configured to:
receive second address data assigned by a second communications system to geolocation apparatus indicative of the geographic location of the geolocation apparatus;
encrypt the second address data;
transmit encrypted second address data to the data processing apparatus.

32. A communications terminal according to claim 31, wherein said second address data comprises geolocation data.

33. A communications terminal according to claim 31 or 32, wherein the second address data further comprises a second time stamp corresponding to when the second address data was instantiated, the communications terminal further configured to:
encrypt the second time stamp;
transmit encrypted second time stamp data to the data processing apparatus.

34. A communications terminal according to any of claims 31 to 33, further comprising a camera, wherein the communications terminal is configured to include the second address data and a third time stamp in an image file corresponding to an image captured by the camera, the third time stamp corresponding to when the image was captured by the camera.

35. A communications terminal according to claim 34, the communications terminal further configured to:
encrypt the third time stamp;
encrypt the image file;
transmit encrypted third time stamp data and encrypted image file data to the data processing apparatus.

36. A communications terminal according to any of claims 25 to 29, further configured to:
receive an image file;
encrypt the image file;
transmit encrypted image file data to the data processing apparatus.

37. A system operative to automatically verify meta data of a natural or legal person, comprising:
a data processing apparatus as claimed in any of claims 1 to 24; and
a communications terminal as claimed in any of claims 25 to 36.

38. A method of operating data processing apparatus operative to automatically verify meta data of a natural or legal person submitted to the data processing apparatus, the method comprising:
establishing a communications session with a communications terminal through a first communications system;
receiving from the communications terminal first address data defining a geographic location for the communications terminal;
deriving a first geographic location for the communications terminal from the first address data; and
comparing the first geographic location with a street address supplied to the data processing apparatus for the natural or legal person to determine a first geographic correspondence between the first geographic location and the street address.

39. A method according to claim 38, wherein the first geographic correspondence comprises a measure of geographic proximity between the first geographic location and the street address.

40. A method according to claim 38 or 39, further comprising determining if the first geographic correspondence satisfies a first geographic criterion.

41. A method according to claim 40, further comprising indicating a first positive verification of the street address for the first geographic correspondence satisfying the first geographic criterion.

42. A method according to claim 40 or 41, wherein the first geographic criterion comprises the first geographic location and street address being within a predefined distance of each other.

43. A method according to any of claims 38 to 42, wherein the first geographic location comprises a geographic locality.

44. A method according to any of claims 38 to 43, wherein the first address data is supplied from geolocation apparatus and is indicative of the geographic location of the geolocation apparatus.

45. A method according to any of claims 38 to 43, wherein the first address data is address data assigned to a communications origination point for the communications terminal by the first communications system.

46. A method according to claim 45, further comprising:
providing a message for presentation through a user interface of the communications terminal requesting input of second address data assigned by a second communications system to geolocation apparatus indicative of the geographic location of the geolocation apparatus;
receiving the second address data and determine a second geographic location corresponding to the geographic location of the geolocation apparatus from the second address data; and
comparing the street address with the second geographic location to determine a second geographic correspondence between the street address and second geographic location.

47. A method according to claim 46, wherein the second geographic correspondence comprises a measure of geographic proximity between the second geographic location and the street address.

48. A method according to claim 46 or 47, further comprising determining if the second geographic correspondence satisfies a second geographic criterion.

49. A method according to claim 48, further comprising indicating a second positive verification of the street address for the second geographic correspondence satisfying the second geographic condition.

50. A method according to claim 48 or 49, wherein the second geographic criterion comprises the second geographic location and street address being within a predefined distance of each other.

51. A method according to any of claims 46 to 50, further comprising the second geographic correspondence and/or the second geographic criterion being the same as respective first geographic correspondence and first geographic criterion.

52. A method according to any of claims 38 to 51, wherein the geolocation apparatus is configured to receive signals from a satellite system for determining global position of the geolocation apparatus.

53. A method according to claim 52 dependent on any of claims 46 to 51, wherein the second address data is supplied from the geolocation apparatus and is indicative of the geographic location of the geolocation apparatus.

54. A method according to any of claims 46 to 53, wherein the second address data further comprises a time stamp corresponding to when the second address data was instantiated, the method further comprising:
comparing the time stamp with the time the message was provided for presentation on the user interface; and
determining a time difference between the time indicated by the time stamp and the time the message was provided.

55. A method according to claim 54, further comprising indicating a third positive verification of the street address for the time difference being less than a predefined time period.

56. A method according to any of claims 46 to 55, wherein the geolocation apparatus comprises a camera and the second address data is included with an image file corresponding to an image captured by the camera.

57. A method according to claim 56, further comprising:
initiating a search of one or more databases for one or more images corresponding to the location defined by the second address;
comparing at least one of the one or more images with the captured image to determine a level of correspondence therebetween; and
indicating a fourth positive verification of the street address for the level of correspondence being sufficiently great.

58. A method according to claim 56 or 57, further comprising:
providing in the message a request for an image of the natural person engaging in the communications session;
initiating a search of one or more databases for one or more images corresponding to the name of the natural person;
comparing at least one of the one or more images with the image to determine a level of correspondence therebetween; and
indicating a fifth positive verification of the identity of the natural person for the level of correspondence being sufficiently great.

59. A method according to any of claims 38 to 55, further comprising:
providing a personal image request message requesting an image of the natural person engaging in the communications session;
initiating a search of one or more databases for one or more images corresponding to the name of the natural person;
comparing at least one of the one or more images with the image to determine a level of correspondence therebetween; and
indicating a sixth positive verification of the identity of the natural person for the level of correspondence being sufficiently great.

60. A method according to claim 57, further comprising establishing a confirmed positive verification of the street address based on one or more of the first, second, third and fourth positive verification.

61. A method according to claim 58 or 59, further comprising establishing a confirmed positive verification of the natural person based on the fifth or sixth positive verification.

62. A method of operating a communications terminal for receiving input of meta data of a natural of legal person, the method comprising:
establishing a communications session with a data processing apparatus through a first communications system;
encrypting first address data defining a geographic location for the communications terminal;
transmitting encrypted first address data to the data processing apparatus.

63. A method according to claim 62, further comprising:
encrypting input meta data of a natural or legal person;
transmitting encrypted input meta data of the natural or legal person to the data processing apparatus.

64. A method according to claim 62 or 63, wherein said first address data defines a geographic location for the communications terminal.

65. A method according to any of claims 62 to 64, wherein the first address data further comprises a first time stamp corresponding to when the first address data was instantiated, the method further comprising:
encrypting the first time stamp; and
transmitting encrypted first time stamp data to the data processing apparatus.

66. A method according to any of claims 62 to 65, wherein the first address data is supplied from geolocation apparatus and is indicative of the geographic location of the geolocation apparatus.

67. A method according to any of claims 62 to 66, wherein the first address data is address data assigned to a communications origination point for the communications terminal by the first communications system.

68. A method according to claim 67, further comprising:
receiving second address data assigned by a second communications system to geolocation apparatus indicative of the geographic location of the geolocation apparatus;
encrypting the second address data;
transmitting encrypted second address data to the data processing apparatus.

69. A method according to claim 68, wherein said second address data comprises geolocation data.

70. A method according to claim 68 or 69, wherein the second address data further comprises a second time stamp corresponding to when the second address data was instantiated, the method further comprising:
encrypting the second time stamp;
transmitting encrypted second time stamp data to the data processing apparatus.

71. A method according to any of claims 68 to 70, further comprising a camera, wherein the method comprises including the second address data and a third time stamp in an image file corresponding to an image captured by the camera, the third time stamp corresponding to when the image was captured by the camera.

72. A method according to claim 71, the method further comprising:
encrypting the third time stamp;
encrypting the image file;
image file corresponding to an image captured by the camera, the third time stamp corresponding to when the image was captured by the camera.

72. A method according to claim 71, the method further comprising:
encrypting the third time stamp;
encrypting the image file;
transmitting encrypted third time stamp data and encrypted image file data to the data processing apparatus.

73. A method according to any of claims 62 to 70, further comprising:
receiving an image file;
encrypting the image file;
transmitting encrypted image file data to the data processing apparatus.
